(19) United States
(12) Patent Application Publication
(10) Pub. No.: US 2022/0017779 A1
(43) Pub. Date: Jan. 20, 2022

(54) COMPOSITION INCLUDING POLYSILOXANE PHOSPHATE OR PHOSPHONATE AND METHOD OF MAKING A TREATED ARTICLE

(71) Applicant: 3M INNOVATIVE PROPERTIES COMPANY, St. Paul, MN (US)

(72) Inventors: Frans A. Audenaert, Kaprijke (BE); Wayne W. Fan, Cottage Grove, MN (US); Inge Nuyts, Steendorp (BE); Semra Colak Atan, Saint Louis Park, MN (US); Federica Sgolastra, Woodbury, MN (US); George W. Griesgraber, Eagan, MN (US)

(21) Appl. No.: 17/414,828

(22) PCT Filed: Dec. 17, 2019
(86) PCT No.: PCT/IB2019/060956

§ 371 Date: Jun. 16, 2021

Related U.S. Application Data
(60) Provisional application No. 62/932,784, filed on Nov. 8, 2019.
(60) Provisional application No. 62/781,500, filed on Dec. 18, 2018.

(51) Int. Cl. C09D 183/08; C08G 77/30; C08K 5/544; B05D 1/18; B05D 7/14

(52) U.S. Cl. CPC C09D 183/08; C08G 77/30; C08K 5/544; B05D 2518/10; B05D 7/14; B05D 2202/15; B05D 1/18

(57) ABSTRACT

The composition includes a polysiloxane having at least one of a phosphate or phosphonate group and an amino-functional compound having at least one silane group. The method includes treating the metal surface with a composition including a polysiloxane functionalized with at least one of a phosphate or phosphonate group. The method can include first treating the metal surface with a primer composition including an amino-functional compound having at least one silane group or including an amino-functional compound having at least one silane group in the composition with the polysiloxane. Certain polysiloxanes functionalized with at least one of a phosphate or phosphonate group are also described.

### CROSS REFERENCE TO RELATED APPLICATION

This application claims priority to U.S. Provisional Application No. 62/781,500, filed on Dec. 18, 2018, and 62/932,784, filed on Nov. 8, 2019, the disclosures of which are incorporated by reference in their entirety herein.

### BACKGROUND

Various techniques have been used to impart repellent properties to a substrate. For example, silane compounds or compositions having one or more fluorinated groups have been successfully used for rendering substrates such as glass and ceramics oil- and water-repellent. Such silane compounds or compositions have typically included one or more hydrolysable groups and at least one fluorinated alkyl group or fluorinated polyether group. See, for example, U.S. Pat. No. 3,646,085 (Bartlett); U.S. Pat. No. 5,274,159 (Pellerite et al.); U.S. Pat. No. 6,613,860 (Dams et al.); U.S. Pat. No. 6,716,534 (Moore et al.), U.S. Pat. No. 7,470,741 (Dams); and U.S. Pat. No. 7,652,115 (Dams et al.) and Int. Pat. Appl. Pub. No. WO2010/060006 (Hao et al.). Substrates that have been treated for oil and water repellency include glass, ceramics such as bathroom tiles, enamel, metals, natural and man-made stone, polymers, and wood.

Some surface modification techniques have been successfully used with metal surfaces (see, e.g., U.S. Pat. No. 8,158,264 (David et al.) and U.S. Pat. No. 8,945,712 (Dams et al.) and U.S. Pat. Appl. Pub. Nos. 2017/0081523 (Audenaert) and 2018/0282578 (Audenaert et al.). Some of these techniques are expensive and time-consuming and may be difficult to carry out on larger metal or metallized articles, and all of these techniques require the use of fluorochemicals, which have fallen out of favor with some environmental agencies.

### SUMMARY

There continues to be a need for methods for imparting repellent properties to metal surfaces and for articles with metal surfaces having durable oil and water repellency. Metal surfaces are found on a variety of commonly used articles in the home, in vehicles, and outdoors. For example, metal surfaces are popular in kitchens and bathrooms and are used for faucets, sinks, shower heads, hand rails, range hoods, and other appliances. In another example, in automobiles, metal surfaces are used for exterior parts such as wheel rims and for interior handles or decorative panels. In another example, in electronic devices, metal surfaces are used for exterior parts such as backside covers or cases. Such metal surfaces can come in contact with a variety of oily and aqueous deposits such as cooking or automotive oil or grease, food, soap, dirt, sand, and minerals (e.g., lime). These deposits, which may be in the form of fingerprints, stains, or smudges, tend to show up easily on the surface and can be difficult to remove. Removing these deposits often requires aggressive scrubbing, frequently with cleaners or detergents, which may challenge the esthetic appearance of the surface. Easy-to-clean metal surfaces that allow removal of oily and aqueous deposits without the need for aggressive scrubbing and that retain this property after repeated cleaning would, therefore, be advantageous.

We have now found that compositions of polysiloxanes having phosphate or phosphonate groups provide excellent easy-clean performance on metal substrates both on their own and when combined with amino-functional silanes. These compositions do not require the use of fluorochemicals and are surprisingly effective even though they are non-fluorinated.

In one aspect, the present disclosure provides a method of making a treated article having a metal surface. The method includes treating the metal surface with a composition including a polysiloxane functionalized with at least one of a phosphate or phosphonate group.

In another aspect, the present disclosure provides a composition that includes a polysiloxane having at least one of a phosphate or phosphonate group and an amino-functional compound having at least one silane group.

In some embodiments of the aforementioned composition or method, the polysiloxane includes first divalent units independently represented by formula:

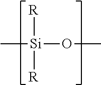

and at least one of
a second divalent unit represented by formula:

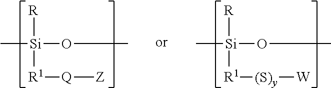

or
a terminal unit represented by formula —R¹-Q′-(Z)_{z} or —R¹—(S)_{y}—W. In some embodiments, the polysiloxane includes a second divalent unit represented by formula:

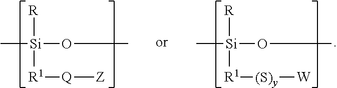

In some embodiments, the polysiloxane includes a terminal unit represented by formula —R¹-Q′-(Z)_{z} or —R¹—(S)_{y}—W. In some embodiments, the polysiloxane includes both a second divalent unit represented by formula:

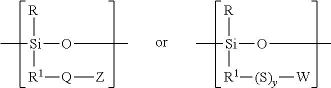

and a terminal unit represented by formula —R¹-Q′-(Z)_{z} or —R¹—(S)_{y}—W.

In these formulas, each R is independently alkyl having up to 8 carbon atoms, haloalkyl having up to 8 carbon atoms, alkenyl having up to 8 carbon atoms, phenyl that is unsubstituted or substituted by at least one alkyl or alkoxy having up to 4 carbon atoms or halogen, or benzyl that is unsubstituted or substituted by at least one alkyl or alkoxy having up to 4 carbon atoms or halogen; each R¹ is independently alkylene, arylene, or alkylene optionally interrupted or terminated by arylene; each Q is independently a bond, alkylene, arylalkylene, alkylarylene, or arylene, wherein the alkylene, arylalkylene, alkylarylene, and arylene are optionally at least one of interrupted or terminated by at least one ether, thioether, amine, amide, ester, thioester, carbonate, thiocarbonate, carbamate, thiocarbamate, urea, thiourea, or a combination thereof; Q′ is a bond or divalent or multivalent alkylene, arylalkylene, alkylarylene, or arylene, wherein the divalent or multivalent alkylene, arylalkylene, alkylarylene, and arylene are optionally at least one of interrupted or terminated by at least one ether, thioether, amine, amide, ester, thioester, carbonate, thiocarbonate, carbamate, thiocarbamate, urea, thiourea, or a combination thereof; y is 0 or 1; z is 1 or 2; W includes divalent units represented by formula:

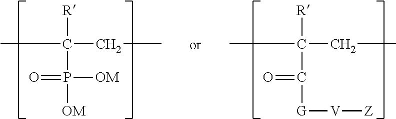

each R′ is independently hydrogen or methyl; each G is independently selected from the group consisting of —O—, —S—, and —N(R¹¹)—; each R¹¹ is independently selected from the group consisting of hydrogen and alkyl having from 1 to 4 carbon atoms; V is alkylene that is optionally interrupted by at least one ether linkage or amine linkage; each Z is independently —P(O)(OM)₂ or —O—P(O)(OM)₂; and each M is independently hydrogen, alkyl, trialkylsilyl, a counter cation, or a bond to the metal surface.

In some embodiments of the aforementioned composition or method, the amino-functional compound is represented by formula (R⁹)₂N—R⁷—[Si(Y)ₚ(R⁸)₃₋ₚ]_{q}, in which R⁷ is a multivalent alkylene group optionally interrupted by one or more —O— groups or up to three —NR⁹— groups; R⁸ is alkyl, aryl, or alkylenyl at least one of interrupted or terminated by aryl; each R⁹ is independently hydrogen, alkyl, aryl, alkylenyl at least one of interrupted or terminated by aryl, or —R⁷—[Si(Y)ₚ(R⁸)₃₋ₚ]; Y is alkoxy, acyloxy, aryloxy, hydroxyl, polyalkyleneoxy, or halogen; p is 1, 2, or 3; and q is 1, 2, or 3. In some embodiments, at least two independently selected —Si(Y)ₚ(R⁸)₃₋ₚ groups are present. In some embodiments, both R⁹ groups are not hydrogen, and the amino-functional compound has a secondary or tertiary amino group. In some embodiments, q is 1.

In another aspect, the present disclosure provides a polysiloxane having first divalent units independently represented by formula:

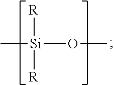

and at least one of
a second divalent unit represented by formula:

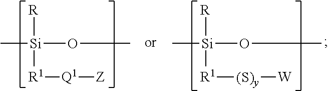

or
a terminal unit represented by formula —R¹-Q¹-Z or —R¹—(S)_{y}—W. In these formulas, each R is independently alkyl having up to 8 carbon atoms, haloalkyl having up to 8 carbon atoms, alkenyl having up to 8 carbon atoms, phenyl that is unsubstituted or substituted by at least one alkyl or alkoxy having up to 4 carbon atoms or halogen, or benzyl that is unsubstituted or substituted by at least one alkyl or alkoxy having up to 4 carbon atoms or halogen; each R¹ is independently alkylene, arylene, or alkylene optionally interrupted or terminated by arylene; each Q¹ is independently alkylene, arylalkylene, alkylarylene, or arylene, wherein the alkylene, arylalkylene, alkylarylene, and arylene are at least one of interrupted or terminated by at least one amine, amide, ester, thioester, carbonate, thiocarbonate, carbamate, thiocarbamate, urea, thiourea, or a combination thereof; y is 0 or 1; each W independently includes divalent units represented by formula

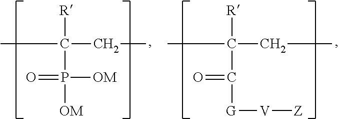

or a combination thereof; each R′ is independently hydrogen or methyl; each G is independently selected from the group consisting of —O—, —S—, and —N(R¹¹)—; each R¹¹ is independently selected from the group consisting of hydrogen and alkyl having from 1 to 4 carbon atoms; each V is independently alkylene that is optionally interrupted by at least one ether linkage or amine linkage; each Z is independently —P(O)(OM)₂ or —O—P(O)(OM)₂; and each M is independently hydrogen, alkyl, trialkylsilyl, or a counter cation.

As used herein, the terms “alkyl” and the prefix “alk” are inclusive of both straight chain and branched chain groups and of cyclic groups, e.g., cycloalkyl. Unless otherwise specified, these groups contain from 1 to 20 carbon atoms. In some embodiments, these groups have a total of up to 10 carbon atoms, up to 8 carbon atoms, up to 6 carbon atoms, or up to 4 carbon atoms. Cyclic groups can be monocyclic or polycyclic and preferably have from 3 to 10 ring carbon atoms.

The term “alkylene” is the divalent or trivalent form of the “alkyl” groups defined above.

Unless otherwise indicated, the term “halogen” refers to a halogen atom or one or more halogen atoms, including chlorine, bromine, iodine, and fluorine atoms.

The term “aryl” as used herein includes carbocyclic aromatic rings or ring systems optionally containing at least one heteroatom (i.e., O, N, or S). Examples of aryl groups include phenyl, naphthyl, biphenyl, and pyridinyl.

The term “arylene” is the divalent form of the “aryl” groups defined above.

“Arylalkylene” refers to an “alkylene” moiety to which an aryl group is attached.

“Arylalkylenyl” refers to a terminal aryl group attached to an “alkylene” moiety.

The term “carbamate” refers to the group —O—C(O)—N(R′)— wherein R′ is as defined below.

The term “urea” refers to the group —N(R′)—C(O)—N(R′)— wherein each R′ is independently as defined below.

The term “hydrolysable group” refers to a group which either is directly capable of undergoing condensation reactions under appropriate conditions or which is capable of hydrolyzing under appropriate conditions to yield a compound that is capable of undergoing condensation reactions. Appropriate conditions typically refer to the presence of water and optionally the presence of acid or base.

The term “non-hydrolysable group” refers to a group generally not capable of hydrolyzing under the appropriate conditions described above for hydrolyzing hydrolysable groups, (e.g., acidic or basic aqueous conditions).

The term (meth)acrylate refers to both acrylate and methacrylate, in the alternative or in combination.

As used herein, “a,” “an,” “the,” “at least one,” and “one or more” are used interchangeably.

The phrases “at least one of” and “comprises at least one of” followed by a list refers to any one of the items in the list and any combination of two or more items in the list.

Also herein, the recitations of numerical ranges by endpoints include all numbers subsumed within that range, including the endpoints (e.g., 1 to 5 includes 1, 1.5, 2, 2.75, 3, 3.80, 4, 5, etc.). When the number is an integer, then only the whole numbers are included (e.g., 1, 2, 3, 4, 5, etc.).

The above summary is not intended to describe each disclosed embodiment or every implementation of the present disclosure. The description that follows more particularly exemplifies illustrative embodiments. In several places throughout the application, guidance is provided through lists of examples, which examples can be used individually and in various combinations. In each instance, the recited list serves only as a representative group and should not be interpreted as an exclusive list.

### DETAILED DESCRIPTION

In general, polysiloxanes useful in the composition and method of the present disclosure include divalent units represented by formula I.

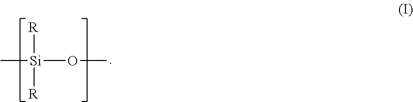

In formula I, each R is independently alkyl having up to 8 carbon atoms, haloalkyl having up to 8 carbon atoms, alkenyl having up to 8 carbon atoms, phenyl that is unsubstituted or substituted by at least one alkyl or alkoxy having up to 4 carbon atoms or halogen, or benzyl that is unsubstituted or substituted by at least one alkyl or alkoxy having up to 4 carbon atoms or halogen. Suitable alkyl groups for R in formula I typically have 1 to 10, 1 to 6, or 1 to 4 carbon atoms. Examples of useful alkyl groups include methyl, ethyl, isopropyl, n-propyl, n-butyl, and iso-butyl. Suitable haloalkyl R groups often have only a portion of the hydrogen atoms of the corresponding alkyl group replaced with a halogen. Examples of haloalkyl groups include chloroalkyl and fluoroalkyl groups with 1 to 3 halo atoms and 3 to 10 carbon atoms. Suitable alkenyl R groups often have 2 to 10 carbon atoms. Examples of alkenyl groups often have 2 to 8, 2 to 6, or 2 to 4 carbon atoms such as ethenyl, n-propenyl, and n-butenyl. The phenyl group and benzyl group can be unsubstituted or substituted with an alkyl (e.g., an alkyl having 1 to 10 carbon atoms, 1 to 6 carbon atoms, or 1 to 4 carbon atoms), an alkoxy (e.g., an alkoxy having 1 to 10 carbon atoms, 1 to 6 carbon atoms, or 1 to 4 carbon atoms), or halo (e.g., chloro, bromo, or fluoro).

In some embodiments, the polysiloxane of the present disclosure and/or useful in the composition and method of the present disclosure includes at least one (in some embodiments, at least 1, 2, 5, 10, 15, 20, or at least 25) divalent unit represented by formula II:

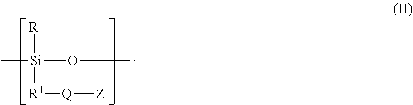

In formula II, each R is as defined above in any of the definitions described for formula I. In formula II, each R¹ is independently alkylene, arylene, or alkylene at least one of interrupted or terminated by arylene. In some embodiments, each R¹ is independently alkylene having 1 to 10, 1 to 6, or 1 to 4 carbon atoms. Each Q is independently a bond, alkylene, arylene, or alkylene at least one of interrupted or terminated by aryl, wherein the alkylene, arylene, and alkylene at least one of interrupted or terminated by aryl are optionally at least one of interrupted or terminated by at least one ether (i.e., —O—), thioether (i.e., —S—), amine (i.e., —NR¹¹—), amide (i.e., —N(R¹¹)—C(O)— or —C(O)—N(R¹¹)—), ester (i.e., —O—C(O)— or —C(O)—O—), thioester (i.e., —S—C(O)— or —C(O)—S—), carbonate (i.e., —O—C(O)—O—), thiocarbonate (i.e., —S—C(O)—O— or —O—C(O)—S—), carbamate (i.e., —(R¹¹)N—C(O)—O— or —O—C(O)—N(R¹¹)—, thiocarbamate (i.e., —N(R¹¹)—C(O)—S— or —S—C(O)—N(R¹¹)—, urea (i.e., —(R¹¹)N—C(O)—N(R¹¹)—), or thiourea (i.e., —(R¹¹)N—C(S)—N(R¹¹)—). In any of these groups that include an R¹¹, R¹¹ is hydrogen, alkyl, aryl, or alkylenyl at least one of interrupted or terminated by aryl. In some embodiments, R¹¹ is hydrogen or alkyl, for example, having 1 to 4 carbon atoms (e.g., methyl, ethyl, n-propyl, isopropyl, n-butyl, isobutyl, or sec-butyl). In some embodiments, R¹¹ is methyl or hydrogen. The phrase “interrupted by at least one functional group” refers to having part of the alkylene, arylalkylene, or alkylarylene group on either side of the functional group. An example of an alkylene interrupted by an ether is —CH₂—CH₂—O—CH₂—CH₂—. Similarly, an alkylene that is interrupted by arylene has part of the alkylene on either side of the arylene (e.g., —CH₂—CH₂—C₆H₄—CH₂—). It should be understood that when Q is a bond, formula II can also be represented by formula

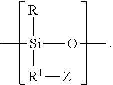

In some embodiments, each Q is independently alkylene that is optionally at least one of interrupted or terminated by at least one ether, thioether, or combination thereof. The alkylene can have 1 to 10, 1 to 6, or 1 to 4 carbon atoms. In some embodiments, Q is —O-alkylene or —S-alkylene having 1 to 10, 1 to 6, or 1 to 4 carbon atoms. These are examples of alkylenes that are terminated by ether or thioether groups. The terminal groups are typically connected to R¹. In some embodiments, Q is a poly(alkylene oxide) group optionally terminated by an ether or thioether group. Suitable poly(alkylene oxide) groups include those represented by formula (OR¹⁰)ₛ, in which each OR¹⁰ is independently —OCH₂CH₂—, —OCH(CH₃)CH₂—, —OCH₂CH₂CH₂—, —OCH₂CH(CH₃)—, —OCH₂CH₂CH₂CH₂—, —OCH(CH₂CH₃)CH₂—, —OCH₂CH(CH₂CH₃)—, and —OCH₂C(CH₃)₂—. In some embodiments, each OR¹⁰ independently represents —OCH₂CH₂—, —OCH(CH₃)CH₂- or —OCH₂CH(CH₃)—. Each s is independently a value from 5 to 300 (in some embodiments, from 10 to about 250, or from 20 to about 200).

In some embodiments, each Q is Q¹, and each Q¹ is independently alkylene, arylalkylene, alkylarylene, or arylene, wherein the alkylene, arylalkylene, alkylarylene, and arylene are at least one of interrupted or terminated by at least one amine, amide, ester, thioester, carbonate, thiocarbonate, carbamate, thiocarbamate, urea, thiourea, or a combination thereof. In some embodiments, each Q¹ is independently alkylene at least one of interrupted or terminated by at least one amine, amide, ester, thioester, carbamate, thiocarbamate, or a combination thereof. In some embodiments, each Q¹ is independently alkylene at least one of interrupted or terminated by at least one amine, amide, ester, carbamate, or a combination thereof. In some embodiments, each Q¹ is independently alkylene at least one of interrupted or terminated by at least one amine, ester, or a combination thereof. In some embodiments, Q¹ is —NH-alkylene-C(O)—O-alkylene having 1 to 10, 1 to 6, or 1 to 4 carbon atoms. These are examples of alkylenes that are terminated by amine and interrupted by ester groups.

In formula II, each Z is independently —P(O)(OM)₂ or —O—P(O)(OM)₂, and each M is independently hydrogen, alkyl, trialkylsilyl, a counter cation, or a bond to the metal surface. In some embodiments, each Z is —P(O)(OM)₂. In some embodiments, each Z is —O—P(O)(OM)₂. In some embodiments, each M is hydrogen. In some embodiments, at least one M is a counter cation. Examples of M counter cations include alkali metal (e.g., sodium, potassium, and lithium), ammonium, alkyl ammonium (e.g., tetraalkylammonium), and five to seven membered heterocyclic groups having a positively charged nitrogen atom (e.g, a pyrrolium ion, pyrazolium ion, pyrrolidinium ion, imidazolium ion, triazolium ion, isoxazolium ion, oxazolium ion, thiazolium ion, isothiazolium ion, oxadiazolium ion, oxatriazolium ion, dioxazolium ion, oxathiazolium ion, pyridinium ion, pyridazinium ion, pyrimidinium ion, pyrazinium ion, piperazinium ion, triazinium ion, oxazinium ion, piperidinium ion, oxathiazinium ion, oxadiazinium ion, and morpholinium ion). In some embodiments, for example, of the method of the present disclosure, M is a bond to the metal surface.

In some embodiments of the composition or method of the present disclosure, the polysiloxane comprises the second divalent unit represented by formula II, each R¹ is independently alkylene, each Q is independently a bond or alkylene optionally at least one of interrupted or terminated by at least one ether or thioether; and Z is —P(O)(OM)₂ or —O—P(O)(OM)₂, wherein each M is independently hydrogen, a counter cation, or a bond to the metal surface. In some embodiments of the composition, each M is independently hydrogen or a counter cation.

In some embodiments, the polysiloxane useful in the composition and method of the present disclosure includes at least one (in some embodiments, at least 1, 2, 5, 10, 15, 20, or at least 25) divalent unit represented by formula III:

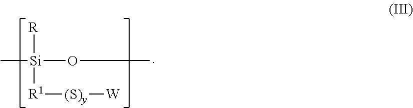

In formula III, each R and R¹ is as defined above in any of the definitions described for formulas I and II. In formula III, y is 0 or 1. In some embodiments, y is 1. W comprises divalent units represented by formula IV or V:

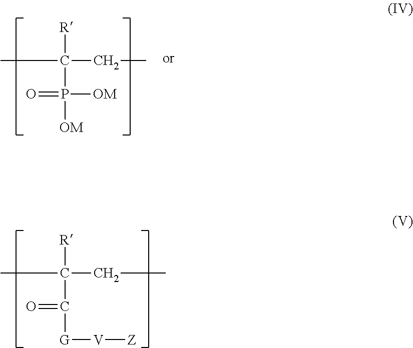

or a combination thereof. In some of these embodiments, W comprises at least one (e.g., at least 1, 2, 5, 10, 15, 20, or at least 25) divalent units represented by formula IV, V, or a combination thereof. In formulas IV and V, G is —O—, —S—, or —N(R¹¹)— (in some embodiments, —O—). Each R′ is independently hydrogen or methyl (in some embodiments, hydrogen, and in some embodiments, methyl). Each R¹¹ is as defined above. In some embodiments, each R¹¹ is independently hydrogen or alkyl having from 1 to 4 carbon atoms (e.g., methyl, ethyl, n-propyl, isopropyl, butyl, isobutyl, or t-butyl). V is alkylene that is optionally interrupted by at least one ether linkage (i.e., —O—) or amine linkage (i.e., —N(R¹¹)—). In some embodiments, V is alkylene having from 2 to 4 (in some embodiments, 2 to 3) carbon atoms. Each M and Z are independently as described above in any of the definitions described for formula II.

In some embodiments, W comprises further divalent units. In some of these embodiments, W comprises at least one (e.g., at least 1, 2, 5, 10, 15, 20, or at least 25) divalent unit represented by formula —[CH₂—(R′) C (Si(X′)_{f}(R¹²)_{3-f})]- or VI:

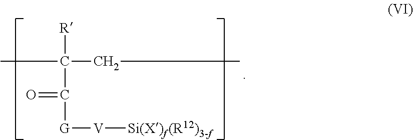

In formula VI, each R′, G, and V are as defined above in any of the definitions described for formulas V. In formula VI and —[CH₂—(R′) C (Si(X′)_{f}(R¹²)_{3-f})]—, X′ is a hydrolyzable group. In some embodiments, each X′ is independently a halide (i.e., fluoride, chloride, bromide, or iodine), hydroxyl (i.e., —OH), alkoxy (e.g., —O-alkyl), aryloxy (e.g., —O-aryl), acyloxy (e.g., —O—C(O)-alkyl), or polyalkyleneoxy (e.g., -[EO]ₕ—[R′O]ᵢ-[EO]ₕ—R″ or —[R′O]ᵢ-[EO]ₕ—[R′O]ᵢ-R″, wherein EO represents —CH₂CH₂O—; each R′O independently represents —CH(CH₃)CH₂O—, —CH₂CH(CH₃)O—, —CH(CH₂CH₃)CH₂O—, —CH₂CH(CH₂CH₃)O—, or —CH₂C(CH₃)₂O— (in some embodiments, —CH(CH₃)CH₂O— or —CH₂CH(CH₃)O—), each h is independently a number from 1 to 150 (in some embodiments, from 7 to about 150, 14 to about 125, 5 to 15, or 9 to 13); and each i is independently a number from 0 to 55 (in some embodiments, from about 21 to about 54, 15 to 25, 9 to about 25, or 19 to 23); and wherein R″ is hydrogen or alkyl having up to four carbon atoms). Alkoxy and acyloxy are optionally substituted by halogen, and aryloxy is optionally substituted by halogen, alkyl (e.g., having up to 4 carbon atoms), or haloalkyl. In some embodiments, alkoxy and acyloxy have up to 6 (or up to 4) carbon atoms. In some embodiments, aryloxy has 6 to 12 (or 6 to 10) carbon atoms. In some embodiments, each X′ is independently selected from the group consisting of halide, hydroxyl, alkoxy, aryloxy, and acyloxy. In some embodiments, each X′ is independently hydroxyl, alkoxy, acetoxy, aryloxy, or halogen. In some embodiments, each X′ is independently selected from the group consisting of halide (e.g., chloride) and alkoxy having up to ten carbon atoms. In some of these embodiments, each X′ is independently alkoxy having from 1 to 6 (e.g., 1 to 4) carbon atoms. In some of these embodiments, each X′ is independently methoxy or ethoxy. In some embodiments, each X′ is independently methoxy, acetoxy, phenoxy, bromo, or chloro. In some of these embodiments, each X′ is independently methoxy, acetoxy, or chloro. In Formula VI and —[CH₂—(R′) C (Si(X′)_{f}(R¹²)_{3-f})]—, each R¹² is independently selected from the group consisting of alkyl (e.g., having from 1 to 6 carbon atoms such methyl, ethyl, n-propyl, isopropyl, butyl, isobutyl, t-butyl, n-pentyl, isopentyl, n-hexyl), aryl (e.g., phenyl); and alkylenyl optionally at least one of interrupted or terminated by aryl. In some of these embodiments, R¹² is alkyl (e.g., methyl or ethyl).

W typically also includes a terminal group, for example, at the end of divalent units represented by formula IV, V, optionally VI or —[CH₂—(R′) C (Si(X′)_{f}(R¹²)_{3-f})]—, or any other divalent units that may be present. Typically, the terminal group is hydrogen. The terminal group can also be a residue from a free-radical initiator. Examples of common initiator residues include hydroxyl groups, alkoxy groups (e.g., tert-butoxy), aroyloxy groups (e.g., benzoyloxy), cyanoalkyl groups (e.g., 2-cyanopropan-2-yl), and substituted versions thereof.

In some embodiments, the polysiloxane useful in the composition and method of the present disclosure includes at least one terminal unit represented by formula —R¹-Q′-(Z)_{z}. In some embodiments, the polysiloxane includes one terminal unit represented by formula —R¹-Q′-(Z)_{z}. In some embodiments, the polysiloxane includes two terminal units represented by formula —R¹-Q′-(Z)_{z}. If the polysiloxane is branched, it can include more than two terminal units represented by formula —R¹-Q′-(Z)_{z}. In formula —R¹-Q′-(Z)_{z}, each R¹ and Z is as defined above in any of the definitions described for formula II. Q′ is a bond or divalent or multivalent alkylene, alkylene interrupted and/or terminated by aryl, or arylene, wherein the divalent or multivalent alkylene, alkylene interrupted and/or terminated by aryl, and arylene are optionally at least one of interrupted or terminated by at least one ether, thioether, amine, amide, ester, thioester, carbonate, thiocarbonate, carbamate, thiocarbamate, urea, thiourea, or a combination thereof, as described above in the definition of Q. In some embodiments, each Q′ is independently alkylene that is optionally at least one of interrupted or terminated by at least one ether, thioether, or combination thereof. The alkylene can have 1 to 10, 1 to 6, or 1 to 4 carbon atoms. In some embodiments, Q′ is —O-alkylene or —S-alkylene having 1 to 10, 1 to 6, or 1 to 4 carbon atoms. These are examples of alkylenes that are terminated by ether or thioether groups. The terminal group is typically attached to R¹. In some embodiments, Q′ is a poly(alkylene oxide) group optionally terminated by an ether or thioether group. Suitable poly(alkylene oxide) groups include those represented by formula (OR¹⁰)ₛ, in which s and each OR¹⁰ is independently as defined above. In some embodiments, Q′ is multivalent. For example, Q′ can be —S-alkylene-(Z)₂, wherein alkylene is branched and optionally interrupted by at least one ester group.

In some embodiments, the polysiloxane according to the present disclosure and/or useful in the composition and method of the present disclosure includes at least one terminal unit represented by formula —R¹-Q′-Z. In some embodiments, the polysiloxane includes one terminal unit represented by formula —R¹-Q′-Z. In some embodiments, the polysiloxane includes two terminal units represented by formula —R¹-Q′-Z. If the polysiloxane is branched, it can include more than two terminal units represented by formula —R¹-Q′-Z. In formula —R¹-Q¹-Z_{z}, each R¹ and Z is as defined above in any of the definitions described for formula II. Q¹ is a bond or divalent or multivalent alkylene, alkylene interrupted and/or terminated by aryl, or arylene, wherein the divalent or multivalent alkylene, alkylene interrupted and/or terminated by aryl, and arylene are at least one of interrupted or terminated by at least one amine, amide, ester, thioester, carbonate, thiocarbonate, carbamate, thiocarbamate, urea, thiourea, or a combination thereof, as described above in the definition of Q. In some embodiments, each Q¹ is independently alkylene at least one of interrupted or terminated by at least one amine, amide, ester, carbamate, or a combination thereof. In some embodiments, each Q¹ is independently alkylene at least one of interrupted or terminated by at least one amine, ester, or a combination thereof. In some embodiments, Q¹ is —NH-alkylene-C(O)-O-alkylene having 1 to 10, 1 to 6, or 1 to 4 carbon atoms. These are examples of alkylenes that are terminated by amine and interrupted by ester.

In some embodiments of the polysiloxane, composition, or method of the present disclosure, the polysiloxane comprises two terminal groups independently represented by formula —R¹-Q′-Z, each R¹ is independently alkylene, each Q¹ is independently alkylene at least one of interrupted or terminated by at least one amine, ester, or a combination thereof; and Z is —P(O)(OM)₂, wherein each M is independently hydrogen, a counter cation, or a bond to the metal surface. In some embodiments of the composition, each M is independently hydrogen or a counter cation.

In some embodiments, the polysiloxane useful in the composition and method of the present disclosure includes at least one terminal unit represented by formula —R¹—(S)_{y}—W. In formula —R¹—(S)_{y}—W, each R¹, y, and W is as defined above in any of the definitions described for formulas II and III. In other words, W can include divalent units represented by formula IV, V, optionally VI, and a terminal group such as hydrogen or a residue from a free-radical initiator. In some embodiments, y is 1.

In some embodiments, in the divalent units of formulas I, II, and III collectively, at least 40 percent, and in some embodiments at least 50 percent, of the R groups are phenyl, methyl, or combinations thereof. For example, at least 60 percent, at least 70 percent, at least 80 percent, at least 90 percent, at least 95 percent, at least 98 percent, or at least 99 percent of the R groups can be phenyl, methyl, or combinations thereof. In some embodiments, in the divalent units of formula I, II, and III collectively, at least 40 percent, and in some embodiments at least 50 percent, of the R groups are methyl. For example, at least 60 percent, at least 70 percent, at least 80 percent, at least 90 percent, at least 95 percent, at least 98 percent, or at least 99 percent of the R groups can be methyl. The remaining R groups can be selected from an alkyl having at least two carbon atoms, haloalkyl, alkenyl, phenyl, or phenyl substituted with an alkyl, alkoxy, or halogen.

In some embodiments, polysiloxanes useful in the composition and method of the present disclosure can be represented by formula VII or VIII:

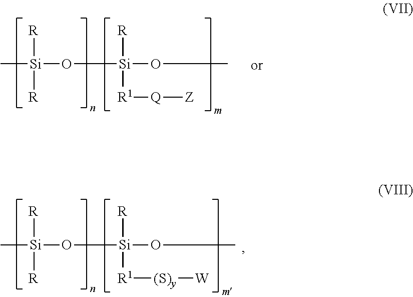

either of which may or may not include a terminal unit represented by formula —R¹-Q′-(Z)_{z} or —R¹—(S)_{y}—W, wherein R, R¹, Q, Z, Q′, z, y, and W are as defined above in any of their embodiments, and n+m or n+m′ is in a range from 10 to 500, 10 to 400, 10 to 300, 12 to 300, 13 to 300, 13 to 200, 10 to 100, 10 to 50, or 10 to 30. Such values of n+m or n+m′ provide polysiloxanes having number average molecular weights of up to about 40,000, 30,000, 25,000, 15,000, 10,000, 5,000, or 2,250 grams per mole. In some embodiments, the polysiloxane has a number average molecular weight of at least 750 grams per mole, at least 900 grams per mole, or at least 1000 grams per mole Polysiloxanes disclosed herein typically have a distribution of molecular weights. The number of repeating units and the molecular weights of polysiloxanes can be determined, for example, by nuclear magnetic resonance (NMR) spectroscopy using techniques known to one of skill in the art. Molecular weights, particularly for higher molecular-weight materials, including number average molecular weights and weight average molecular weights, can also be measured, for example, by gel permeation chromatography (i.e., size exclusion chromatography) using techniques known to one of skill in the art. Although formulas VII and VIII are shown as block copolymers, it should be understood that the divalent units of formulas I, II, and III can be randomly positioned in the copolymer. Thus, polysiloxanes useful for practicing the present disclosure also include random copolymers.

In some embodiments, polysiloxanes useful in the composition and method of the present disclosure can be represented by formula IX:

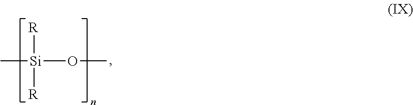

which includes one or more terminal unit represented by formula —R¹-Q′-(Z)_{z} or —R¹—(S)_{y}—W wherein R, R¹, Q′, Z, z, y, and W are as defined above in any of their embodiments, and n is in a range from 10 to 500, 10 to 400, 10 to 300, 12 to 300, 13 to 300, 13 to 200, 10 to 100, 10 to 50, or 10 to 30. Such values of n provide polysiloxanes having number average molecular weights of up to about 40,000, 30,000, 25,000, 15,000, 10,000, 5,000, or 2,250 grams per mole. In some embodiments, the polysiloxane has a number average molecular weight of at least 750 grams per mole or at least 1000 grams per mole Polysiloxanes disclosed herein typically have a distribution of molecular weights, which may be determined using the methods described above.

The above described polysiloxanes represented by formulas VII, VIII, and IX typically include a distribution of oligomers and/or polymers, so n. m and m′ may be non-integral. The above structures are approximate average structures where the approximate average is over this distribution. These distributions may also contain polysiloxanes with no phosphate or phosphonate groups.

Polysiloxanes useful for practicing the present disclosure can be prepared from commercially available or readily obtainable starting materials using a variety of synthetic methods. For example, certain polysiloxanes having terminal or pendant hydroxyl groups are commercially available from Wacker Chemie, AG, Munich, Germany, or can be prepared by known methods (e.g., hydrosilylation of allyl alcohols or other unsaturated alcohols including those having one or more ether linkages). Also, certain polysiloxanes having terminal or pendant mercaptan groups are commercially available from Shin-Etsu Chemical, Tokyo, Japan. Vinyl substituted polysiloxanes, (meth)acrylate-substituted polysiloxanes, carboxylate-substituted polysilanes, and amino substituted polysiloxanes are also known, and some are commercially available (e.g., from Wacker, Shin-Etsu Chemical, or Gelest, Inc., Morrisville, Pa.).

Polysiloxanes having terminal or pendant hydroxyl groups can be treated with phosphating agents to provide polysiloxanes having divalent units represented by formula II or monovalent units represented by formula —R¹-Q′-(Z)_{z} or —R¹-Q′-Z, wherein R¹, Q, Q¹, Q′, and z are as defined above, and Z is —O—P(O)(OM)₂. The reaction may be carried out, for example, with phosphoryl chloride (POCl₃) in the presence of a base such as triethyl amine at room temperature or at an elevated temperature, in a suitable solvent (e.g., ethyl acetate). Polyphosphoric acid may also be useful as a phosphating agent. Polysiloxanes having terminal or pendant hydroxyl groups can also be reacted, for example, with a phosphono carboxylic acid, or an ester or a salt thereof, of formula HOOC—V—P(O)—(OM)₂, wherein V and M as are defined above, under esterification conditions to provide a polysiloxane having divalent units represented by formula II or monovalent units represented by formula —R¹-Q′-(Z)_{z}, wherein R¹, V, and z are as defined above, Q or Q′ is interrupted or terminated by an ester group, and Z is —P(O)(OM)₂. In some embodiments, the phosphono carboxylic acid is 2-phosphonoacetic acid or 3-phosphonopropionic acid. The reaction may be carried out, for example, at an elevated temperature, in a suitable solvent (e.g., a ketone or an ether), optionally in the presence of a catalyst (e.g., methanesulfonic acid). Polysiloxanes having terminal or pendant amine groups can also be reacted, for example, with a phosphono carboxylic acid, or an ester or a salt thereof, of formula HOOC—V—P(O)—(OM)₂, wherein V and M are as defined above to provide a polysiloxane having divalent units represented by formula II or monovalent units represented by formula —R¹-Q′-(Z)_{z} or —R¹-Q′-Z, wherein R¹, V, and z are as defined above, Q, Q¹, or Q′ is interrupted or terminated by an amide group, and Z is —P(O)(OM)₂.

The hydroxyl group in a polysiloxane can also be converted to a good leaving group (e.g., mesylate or tosylate) and treated with amino-functional phosphonic acids or their salts or esters. For example, the mesylate can react with aminomethyl phosphonic acid, 2-aminoethyl phosphonic acid, 3-aminopropyl phosphonic acid, or salts (e.g., sodium salt) or esters of any of these acids to provide a polysiloxane having divalent units represented by formula II or monovalent units represented by formula —R¹-Q′-(Z)_{z} or —R¹-Q¹-Z, wherein R¹, V, and z are as defined above, Q, Q¹, or Q′ is interrupted or terminated by an amino group, and Z is —P(O)(OM)₂. Phosphite esters can also be useful nucleophiles to displace the activated hydroxyl group and provide a polysiloxane having divalent units represented by formula II or monovalent units represented by formula —R¹-Q′-(Z)_{z} or —R¹-Q′-Z, wherein R¹, Q, Q¹, or Q′ V, and z are as defined above, and Z is —P(O)(OM)₂.

Polysiloxanes having terminal carboxylic acid groups can be converted, for example, to a carboxylic acid ester, which can then be reacted with an amino alcohol (e.g., ethanolamine or 3-amino-1,2-propanediol) to prepare a polysiloxane having at least one terminal group —R¹-Q′-(Z)_{z} or —R¹-Q′-Z, wherein R¹ is as defined in any of the above embodiments, Q′ or Q¹ is terminated by an amide group, and z is 1 or 2. The reaction can be carried out at room temperature or an elevated temperature, optionally in a suitable solvent. The resulting hydroxyl compound can then be treated with, for example, any of the phosphating agents described above, or it can be treated with a phosphono carboxylic acid, or an ester or a salt thereof, of formula HOOC—V—P(O)—(OM)₂, as described above.

(Meth)acrylate substituted polysiloxanes can be treated, for example, with amino-functional phosphonic acids or their salts or esters (e.g., aminomethyl phosphonic acid, 2-aminoethyl phosphonic acid, 3-aminopropyl phosphonic acid, or their salts (e.g., sodium salt) or esters) to prepare polysiloxane having divalent units represented by formula II or monovalent units represented by formula —R¹-Q′-(Z)_{z} or —R¹-Q¹-Z, wherein R¹ and z are as defined above, Q, Q¹, or Q′ is interrupted or terminated by an ester group and amino group, and Z is —P(O)(OM)₂. The reaction between (meth)acrylate esters and amines are optionally carried out in dry solvent and optionally in the presence of 0.05 percent to 2 percent by weight catalyst (e.g., a base such as 1,4-dihydropyridines, methyl diphenylphosphane, methyl di-p-tolylphosphane, 2-allyl-N-alkyl imidazolines, tetra-t-butylammonium hydroxide, DBU (1,8-diazabicyclo[5.4.0]undec-7-ene), tetramethylguanidine, DBN (1,5-diazabicyclo[4.3.0]non-5-ene), potassium methoxide, sodium methoxide, or sodium hydroxide). Conveniently, the reaction can be carried out at room temperature. Using these reaction conditions, polysiloxanes having terminal or pendant amino groups can be reacted with compounds of formula (MO)₂(O)P—C(R′)═CH₂, or Z—V-G-C(O)—C(R′)═CH₂, for example, can be useful for making polysiloxanes having a divalent unit represented by formula II or a terminal unit represented by formula —R¹-Q′-(Z)_{z} or —R¹-Q′-Z, in which Q, Q¹, or Q′ is terminated with an amino group and optionally interrupted with an ester group. Useful commercially available compounds of formulas (MO)₂(O)P—C(R′)═CH₂, or Z—V-G-C(O)—C(R′)═CH₂ include vinyl phosphonic acid and ethylene glycol methacrylate phosphate. [2-(Acryloyloxy)ethyl]phosphonate and its esters can be prepared, for example, by treating hydroxyethylphosphonate dimethyl ester with acryloyl chloride using conventional methods as described in the Examples, below.

Polysiloxanes having terminal or pendant mercaptan or vinyl groups can be useful for making polysiloxanes having a divalent unit represented by formulas II or III or a terminal unit represented by formula —R¹-Q′-(Z)_{z} or —R¹—(S)_{y}—W under free radical conditions by reaction with compound of formula (MO)₂(O)P—C(R′)═CH₂, or Z—V-G-C(O)—C(R′)═CH₂, for example. Useful free radical initiators include hydrogen peroxide, potassium persulfate, t-butyl hydroperoxide, benzoyl peroxide, t-butyl perbenzoate, cumene hydroperoxide, 2,2′-azobis(2-methylbutyronitrile), azobis(isobutyronitrile) (AIBN), and free radical photoinitiators such as those described by K. K. Dietliker in Chemistry & Technology of UV & EB Formulation for Coatings, Inks & Paints, Volume 3, pages 276-298, SITA Technology Ltd., London (1991).

By using excess compounds of formula (MO)₂(O)P—C(R′)═CH₂, or Z—V-G-C(O)—C(R′)═CH₂, polymerization can occur to provide polysiloxanes having divalent units of formula III or terminal units represented by formula —R¹—(S)_{y}—W, in which W includes divalent units represented by formula IV or V. By the term “polymerizing” it is meant forming a polymer or oligomer that includes at least one identifiable structural element due to each of the components. Typically, the polymer that is formed has a distribution of molecular weights and compositions. The polymer may have one of many structures (e.g., a random graft copolymer or a block copolymer). Additional monomers may be added in a polymerization reaction to provide additional polysiloxanes useful for the compositions and methods disclosed herein. For example, 3-methacryloxypropyl trimethoxysilane, vinyltrimethoxy silane, vinyltriethoxysilane, and silicone acrylates available, for example, from Shin-Etsu Silicones of America, Inc., Akron, Ohio, under the trade designation “X22-2426” may be useful for incorporating silane-containing divalent units into the W group in polysiloxanes described herein. In some embodiments, the polymer or oligomer that is formed is a random graft copolymer. In some embodiments, the polymer or oligomer that is formed is a block copolymer.

In some embodiments, the free-radical reaction is carried out in solvent. The reactants may be present in the reaction medium at any suitable concentration, (e.g., from about 5 percent to about 80 percent by weight based on the total weight of the reaction mixture). Illustrative examples of suitable solvents include aliphatic and alicyclic hydrocarbons (e.g., hexane, heptane, cyclohexane), aromatic solvents (e.g., benzene, toluene, xylene), ethers (e.g., diethyl ether, glyme, diglyme, and diisopropyl ether), esters (e.g., ethyl acetate and butyl acetate), alcohols (e.g., ethanol and isopropyl alcohol), ketones (e.g., acetone, methyl ethyl ketone and methyl isobutyl ketone), halogenated solvents (e.g., methylchloroform, 1,1,2-trichloro-1,2,2-trifluoroethane, trichloroethylene, and trifluorotoluene, and mixtures thereof.

Temperature and solvent for a particular free-radical reaction can be selected by those skilled in the art based on considerations such as the solubility of reagents, temperature required for the use of a particular initiator, and desired molecular weight for a polymerization. While it is not practical to enumerate a particular temperature suitable for all initiators and all solvents, generally suitable temperatures are in a range from about 30° C. to about 200° C. (in some embodiments, from about 40° C. to about 100° C., or from about 50° C. to about 80° C.).

Free-radical polymerizations may be carried out in the presence of chain transfer agents. Typical chain transfer agents that may be used in the preparation for some compositions described herein include hydroxyl-substituted mercaptans (e.g., 2-mercaptoethanol, 3-mercapto-2-butanol, 3-mercapto-2-propanol, 3-mercapto-1-propanol, and 3-mercapto-1,2-propanediol (i.e., thioglycerol)); poly(ethylene glycol)-substituted mercaptans; carboxy-substituted mercaptans (e.g., mercaptopropionic acid or mercaptoacetic acid): amino-substituted mercaptans (e.g., 2-mercaptoethylamine); difunctional mercaptans (e.g., di(2-mercaptoethyl)sulfide); and aliphatic mercaptans (e.g., octylmercaptan, dodecylmercaptan, and octadecylmercaptan).

Adjusting, for example, the concentration and activity of the initiator, the concentration of each of the reactive monomers, the temperature, the concentration of the chain transfer agent, and the solvent using techniques known in the art can control the molecular weight of a polysiloxane copolymer.

Further details about the preparation of polysiloxanes having at least one of a phosphate or phosphonate group useful for practicing the present disclosure can be found in the Examples, below, and references cited therein.

Compositions and/or methods of the present disclosure optionally include an amino-functional compound having at least one silane group. Amino-functional silanes useful for practicing the present disclosure include at least one amino group and at least one silane group, and the amino group and the silane group are connected by an organic linking group. Silane groups useful in the compositions of the present disclosure include at least one hydrolyzable group. The term “hydrolyzable group” refers to a group which either is directly capable of undergoing condensation reactions under appropriate conditions or which is capable of hydrolyzing under appropriate conditions to yield a compound that is capable of undergoing condensation reactions. Appropriate conditions typically refer to the presence of water and optionally the presence of acid or base. Examples of hydrolysable groups include any of the X′ groups defined above. Any of these groups can be used as Y groups in formulas XI, XII, below. Hydrolyzable groups (e.g., X′ and Y groups herein) are generally capable of hydrolyzing, for example, in the presence of water to produce silanol groups.

Silane groups in the amino-functional compound having at least one silane group can include one or two non-hydrolyzable groups. The term “non-hydrolyzable group” refers to a group generally not capable of hydrolyzing under the appropriate conditions described above for hydrolyzing hydrolyzable groups, (e.g., in water or acidic or basic aqueous conditions). Non-hydrolyzable groups include R¹² groups defined above and R⁵ and R⁸ groups defined in formulas XI and XII, below. In some embodiments, the amino-functional compound having at least one silane group does not include non-hydrolyzable groups.

In some embodiments, the amino-functional compound useful for practicing the present disclosure is represented by formula XI: (R⁹)₂N—R⁷—[Si(Y²)ₚ(R⁸)₃₋ₚ]_{q}. In formula XI, R⁷ is a multivalent alkylene group optionally interrupted by one or more —O— groups or up to three —NR⁹— groups. In some embodiments, R⁷ is interrupted by up to three —O— groups. In embodiments in which R⁷ is interrupted by up to three —NR⁹— groups, the amino-functional compound includes diamino-functional silanes, triamino-functional silanes, and tetraamino-functional silanes, for example. In some embodiments, R⁷ is a divalent alkylene group. In some embodiments, R⁷ is a divalent alkylene group having up to 6 (in some embodiments, 5, 4, or 3) carbon atoms. In some embodiments, R⁷ is a divalent alkylene group interrupted by one or two —NR⁹— groups and is represented by formula —CH₂—CH₂—N(R⁹)—CH₂—CH₂—CH₂— or —CH₂—CH₂—N(R⁹)—CH₂—CH₂—N(R⁹)—CH₂—CH₂—CH₂—.

In some embodiments, the amino-functional compound useful for practicing the present disclosure can be represented by formula XII:

(R⁶)₂N—[R⁴—Z′]ᵣ—R⁴—[Si(Y)ₚ(R⁵)₃₋ₚ] (XII)

In formula XII, —[R⁴—Z′]ᵣ—R⁴— represents the organic linking group. Each R⁴ is independently arylene or alkylene optionally interrupted or terminated by arylene. In some embodiments, each R⁴ is independently a divalent alkylene group. In some embodiments, each R⁴ is independently a divalent alkylene group having up to 6 (in some embodiments, 5, 4, or 3) carbon atoms. Each Z′ is independently —O— or —NR⁶—, and r is 0, 1, 2, or 3. In some embodiments, r is 0. In some embodiments, each Z is —NR⁶—. In some embodiments, r is 1, 2, or 3. In some embodiments, r is 1 or 2. In embodiments in which r is 1, 2, or 3, the second amino-functional silane includes diamino-functional silanes, triamino-functional silanes, and tetraamino-functional silanes, for example. In some embodiments in which r is greater than 0, —[R⁴—Z′]ᵣ—R⁴— is represented by formula —CH₂—CH₂—N(R⁶)—CH₂—CH₂—CH₂— or —CH₂—CH₂—N(R⁶)—CH₂—CH₂—N(R⁶)—CH₂—CH₂—CH₂—.

In formulas XI and XII, each R⁵ or R⁸ can independently be alkyl, aryl, or alkylenyl interrupted or terminated by aryl. In some embodiments, R⁵ or R⁸ is alkyl or arylalkylenyl. In some of these embodiments, R or R is alkyl (e.g., methyl or ethyl).

In formulas XI and XII, each R⁶ or R⁹ is independently hydrogen, alkyl, aryl, alkylenyl interrupted or terminated by aryl, —R⁴—[Si(Y)ₚ(R⁵)₃₋ₚ], or —R⁷—[Si(Y)ₚ(R⁸)₃₋ₚ], where R⁴, R⁵, R⁷, and R⁸ is are defined as in any of the above embodiments. In some embodiments of formulas XI and XII, each R⁶ or R⁹ is independently hydrogen, alkyl, aryl, or arylalkylenyl. In some embodiments, each R⁶ or R⁹ is hydrogen. In some embodiments, at least one R⁶ or R⁹ is alkyl having up to 6 (in some embodiments, up to 5, 4, 3, or 2) carbon atoms. In some embodiments, one of R⁶ or R⁹ is methyl and one of R⁶ or R⁹ is hydrogen. In some embodiments of formula XII, one R⁶ group is hydrogen or alkyl, and the other R⁶ group is —R⁴—[Si(Y)ₚ(R⁵)₃₋ₚ]. In some of these embodiments, one R⁶ group is alkyl, and the other R⁶ group is —R⁴—[Si(Y)ₚ(R⁵)₃₋ₚ]. In some of these embodiments, alkyl may have up to 6 (in some embodiments, up to 5, 4, 3, or 2) carbon atoms. In some embodiments, one R⁶ group is hydrogen or methyl, and the other R⁶ group is —R⁴—[Si(Y)ₚ(R⁵)₃₋ₚ]. In some of these embodiments, one R⁶ group is hydrogen, and the other R⁶ group is —R⁴—[Si(Y)ₚ(R⁵)₃₋ₚ]. Likewise, in some embodiments of formula XI, one R⁹ group is hydrogen or alkyl, and the other R⁹ group is —R⁷—[Si(Y)ₚ(R⁸)₃₋ₚ]. In some of these embodiments, one R⁹ group is alkyl, and the other R⁹ group is —R⁷—[Si(Y)ₚ(R⁸)₃₋ₚ]. In some of these embodiments, alkyl may have up to 6 (in some embodiments, up to 5, 4, 3, or 2) carbon atoms. In some embodiments, one R⁹ group is hydrogen or methyl, and the other R⁹ group is —R⁷—[Si(Y)ₚ(R⁸)₃₋ₚ]. In some of these embodiments, one R⁹ group is hydrogen, and the other R⁹ group is —R⁷—[Si(Y)ₚ(R⁸)₃₋ₚ].

In some embodiments of formula XI and XII, Y can be independently hydroxy, alkoxy, acetoxy, aryloxy, or halogen. In some embodiments, including any of the embodiments described above for R⁴, R⁵, R⁶, R⁷, R⁸, or R⁹, Y is hydroxyl, methoxy, ethoxy, acetoxy, phenoxy, bromo, or chloro. In some embodiments, including any of the embodiments described above for R⁴, R⁵, R⁶, R⁷, R⁸, or R⁹, Y is methoxy, ethoxy, acetoxy, or chloro. Methoxy, ethoxy, acetoxy, and chloro groups on a silane provide low steric hindrance and are readily hydrolyzed to effectively allow for formation of an —Si—O—Si— bond.

In formula XI and XII, p is 1, 2, or 3. In some embodiments, including any of the embodiments described above for R⁴, R⁵, R⁶, R⁷, R⁸, or R⁹, or Y, p is 3.

Examples of useful amino-functional compounds having at least one silane group include 3-aminopropyltrimethoxysilane, [3-(2-aminoethylamino)propyl]trimethoxysilane, 3-[2-(2-aminoethylamino)ethylamino]propyltrimethoxysilane, 3-aminopropyltrimethoxysilane, [3-(2-aminoethylamino)propyl]trimethoxysilane, 3-[2-(2-aminoethylamino)ethylamino]propyltrimethoxysilane, 3-aminopropyltriethoxysilane, [3-(2-aminoethylamino)propyl]triethoxysilane, 3-[2-(2-aminoethylamino)ethylamino]propyltriethoxysilane, and combinations thereof. In some embodiments, the amino-functional compound is a secondary or tertiary amino-functional compound having at least two independently selected silane groups. Examples of such secondary or tertiary amino-functional compounds include bis(3-trimethoxysilylpropyl)amine, bis(3-triethoxysilylpropyl)amine, N-methyl-bis(3-trimethoxysilylpropyl)amine, N-methyl-bis(3-triethoxysilylpropyl)amine, N,N′-bis[3-trimethoxysilylpropyl]-ethylenediamine, N,N-bis[3-trimethoxysilylpropyl]-ethylenediamine, N,N′-bis[3-triethoxysilylpropyl]-ethylenediamine, N,N-bis[3-triethoxysilylpropyl]-ethylenediamine, or a combination thereof. In some embodiments, the amino-functional compound having at least on silane group is bis(3-trimethoxysilylpropyl)amine, bis(3-triethoxysilylpropyl)amine, or a combination thereof.

In some embodiments of methods for making a treated article according to the present disclosure, the amino-functional compound having at least one silane group (in some embodiments, the secondary or tertiary amino-functional compounds having at least two independently selected silane groups) is used as a primer. In some embodiments of the composition and method of the present disclosure, the amino-functional compound having at least one silane group is included in the composition with the polysiloxane.

As shown in Tables 3 and 10, in some embodiments, a synergy is observed for the combination of polysiloxane functionalized with a phosphonate or phosphate and an amino-functional compound having at least one silane group. In the presence of the amino-functional compound having at least one silane group, an improved water contact angle value can be obtained even when less polysiloxane is applied. The amino-functional silane used either in combination with the polysiloxane or as a primer in general increases the initial water contact angle and the stain repellency of the treated substrate.

In some embodiments, compositions according to the present disclosure and/or useful for practicing some embodiments of the methods disclosed herein include an organic solvent. As used herein, the term “an organic solvent” includes a single organic solvent and a mixture of two or more organic solvents. Examples of suitable organic solvents include alcohols (e.g., methanol, ethanol, and isopropanol); ketones (e.g., acetone, 2-butanone, and 2-methyl-4-pentanone); esters (e.g., ethyl acetate, butyl acetate, and methyl formate); and ethers (e.g., diethyl ether, diisopropyl ether, methyl t-butyl ether, 1-methoxy-2-propanol, and dimethoxyethane (glyme)).

In some embodiments, compositions according to the present disclosure and/or useful for practicing some embodiments of the methods disclosed herein include an organic solvent having a flashpoint of at least 40° C. In some embodiments, the organic solvent has a flashpoint of at least 45° C., at least 50° C., or at least 60° C. Examples of suitable organic solvents include ethers (e.g., bis(2-methoxyethyl)ether (diglyme), dipropylene glycol dimethyl ether (DMM), and dibutoxymethane (butylal)); ether-alcohols (e.g., dipropylene glycol monomethyl ether (DPM), propylene glycol n-butyl ether (PnB), and dipropylene glycol n-butyl ether (DPnB)); esters (e.g., dimethyl succinate (DMS)); ether-esters (e.g., dipropylene glycol methyl ether acetate (DPMA)), alcohol esters (e.g., methyl lactate, ethyl lactate, and butyl lactate); and keto-esters (e.g., methyl acetoacetate (MeAcAc) and t-butyl acetoacetate (tBuAcAc). In some embodiments, the organic solvent has a boiling point of up to 250° C., 230° C., 225° C., 210° C., or 200° C. Such solvents can be readily evaporated after the composition is coated on a substrate, for example. The flashpoints and boiling points for some examples of useful solvents are shown in the table, below. For the purposes of this application, the flashpoint of the organic solvent is measured by the closed cup method.

| Solvent | Fp (° C.) | Bp (° C.) | Solvent | Fp (° C.) | Bp (° C.) |
|---|---|---|---|---|---|
| diglyme | 57 | 162 | DPMA | 86 | 200 |
| DMM | 65 | 175 | Methyl lactate | 49 | 145 |
| butylal | 62 | 182 | Ethyl lactate | 46 | 151 |
| DPM | 75 | 190 | Butyl lactate | 71 | 190 |
| PnB | 63 | 171 | t-BuAcAc | 76 | 190 |
| DPnB | 100 | 230 | MeAcAc | 70 | 170 |
| DMS | 90 | 200 | | | |

Flashpoint is commonly used to classify materials as flammable or combustible. As defined by the U.S. Occupational Safety and Health Administration (OSHA), a flammable liquid has a flashpoint below 100° F. (37.8° C.). Flammable liquids may have components with flashpoints of 100° F. (37.8° C.) or higher if such components make up less than 99 percent of the total volume of the liquid. As defined by the U.S. Department of Transportation (DOT), a flammable liquid has a flashpoint below 141° F. (60.5° C.) or has a flashpoint at or above 100° F. (37.8° C.) and is intentionally heated and offered for transportation or transported at or above its flashpoint in a bulk package. Flammable liquids may have components with flashpoints of 100° F. (37.8° C.) or higher if such components make up less than 99 percent of the total volume of the liquid and the mixture is offered for transportation or transported at or above its flashpoint. A liquid is considered ‘combustible’ when the flashpoint is above 60.5° C. according to DOT and above 37.8° C. according to OSHA. The UN Globally Harmonized System of Classification and Labeling of Chemicals (GHS) is an international system created by the UN to address the classification of chemicals by types of hazard and harmonize hazard communication elements, including labels and safety data sheets. According to GHS, a category 1 flammable liquid has a flashpoint of less than 23° C. and a boiling point of up to 35° C.; a category 2 flammable liquid has a flashpoint of less than 23° C. and a boiling point of greater than 35° C.; a category 3 flammable liquid has a flashpoint of at least 23° C. and a boiling point of up to 60° C.; and a category 4 flammable liquid has a flashpoint of greater than 60° C. and a boiling point of up to 93° C. In some embodiments, compositions according to the present disclosure may be considered nonflammable or combustible according to at least one of the above definitions. Therefore, the compositions may be applied within enclosed environments without requiring explosion-proof equipment.

In some embodiments, the organic solvent comprises a hydrocarbon solvent. Examples of suitable hydrocarbon solvents include gasoline, naphthalenes, xylenes, toluene and toluene derivatives, hexanes, pentanes, ligroin, paraffins and isoparaffins. Some hydrocarbons suitable for use as solvents can be obtained, for example, from SynOil, Calgary, Alberta, Canada under the trade designations “PLATINUM”, “TG-740”, “SF-770”, “SF-800”, “SF-830”, and “SF-840”. Some hydrocarbons suitable for use solvents can be obtained, for example, from ExxonMobil Chemical, Houston, Tex., under the trade designations “ISOPAR” in various grades.

The concentration of the polysiloxane having at least one of a phosphate or phosphonate group, optionally the amino-functional compound of formula XI or XII, and any other components in the organic solvent may be chosen to provide a composition without insoluble fractions. Compositions according to the present disclosure include a concentration of polysiloxane low enough such that the composition is clear or hazy, but no precipitation or phase separation occurs. Such compositions are capable of forming homogeneous coatings on a substrate (e.g., a metal substrate). Whether or not the composition has no insoluble fractions (e.g., no precipitation or phase separation) and/or is capable of forming a homogeneous coating on a substrate depends on a variety of factors, for example, the concentration of the polysiloxane, the concentration of any amino-functional compound, the selection of the organic solvent, and the presence of any other additives. Using the guidance described herein regarding these factors, a person skilled in the art will be able to make a composition without insoluble fractions capable of forming a homogeneous coating on a substrate (e.g., a metal substrate).

The composition according to the present disclosure and/or useful for practicing any embodiments of the methods disclosed herein typically includes from at least 0.01, 0.015, 0.02, 0.025, 0.03, 0.035, 0.04, 0.045, or 0.05 percent by weight, up to 0.1, 0.2, 0.3, 0.4, or 0.5 percent by weight of at least one polysiloxane having at least one of a phosphate or phosphonate group, based on the total weight of the composition. For example, the amount of a polysiloxane in the composition may be in a range of from 0.01 to 0.5, 0.01 to 0.4, 0.01 to 0.3, 0.02 to 0.2, 0.01 to 0.1, or from 0.02 to 0.1 percent by weight, based on the total weight of the composition. Lower or higher amounts of the polysiloxane may also be useful and may be desirable for some applications. Surprisingly, compositions including the polysiloxane having at least one of a phosphate or phosphonate group and optionally an amino-functional compound having at least one silane group can give excellent easy-clean performance on metal substrates even at concentrations of up to 0.4, less than 0.4, up to 0.3, 0.2, or 0.1 percent by weight, based on the total weight of the composition.

Some embodiments of the composition according to the present disclosure and/or useful for practicing any embodiments of the methods disclosed herein can also include from at least 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, or 0.5 percent by weight, up to 1, 1.5, or 2 percent by weight of at least one amino-functional compound, in some embodiments, secondary or tertiary amino-functional compound, based on the total weight of the composition, in addition to the polysiloxane. For example, the amount of an amino-functional compound in a composition may be in a range of from 0.01 to 2, 0.01 to 1, 0.05 to 1, 0.05 to 0.1, or from 0.01 to 0.1 percent by weight, based on the total weight of the composition. Lower or higher amounts of the amino-functional compound may also be useful and may be desirable for some applications.

In some embodiments, compositions according to the present disclosure and/or primer compositions useful for practicing the present disclosure comprise acid. In some embodiments, the acid comprises at least one of (i.e., comprises one or more of) acetic acid, citric acid, formic acid, triflic acid, perfluorobutyric acid, sulfuric acid, or hydrochloric acid. In some embodiments, the acid is hydrochloric acid. Stronger acids typically effect the hydrolysis of silane groups at a lower temperature than weaker acids and are therefore sometimes desirable. The acid may be present in the composition and/or primer composition in a range, for example, from about 0.004, 0.007, 0.01, or 0.015 percent by weight to about 1, 1.5, 2, 2.5, or 3 percent by weight, based on the total weight of the composition. In some embodiments, the acid is present in an amount up to 0.5, 0.4, 0.3, 0.2, or 0.1 percent by weight based on the total weight of the composition. In some embodiments, the acid is hydrochloric acid and is present in the primer composition or treatment composition in a range from 0.004 to 0.05 percent by weight, based on the total weight of the composition. The presence of acid is reported to speed up the rate of hydrolysis of the silane groups in amino-functional compound having at least one silane group or polysiloxane having a silane group (e.g., a divalent unit represented by formula VI. However, advantageously, we have found that no acid catalyst is needed in the composition according to and/or useful for practicing the present disclosure to obtain good easy-to-clean performance. Accordingly, in some embodiments, the composition is essentially free of an acid catalyst. The phrase “essentially free of an acid catalyst” means that the composition may include an acid catalyst in an amount up to 0.003, 0.002, or 0.001 percent by weight, based on the total weight of the composition. Compositions that are “essentially free of an acid catalyst” may also be free of an acid catalyst.

In some embodiments, compositions according to the present disclosure and/or primer compositions useful for practicing the present disclosure comprise water. In some embodiments, the water is present in the composition in a range from 0.01 percent to 5 percent (in some embodiments, 0.05 to 1, 0.05 to 0.5, or 0.1 to 0.5 percent) by weight, based on the total weight of the composition. Water may be added to the composition and/or primer composition separately or may be added as part of an aqueous acidic solution (e.g., concentrated hydrochloric acid is 37% by weight of the acid in water). However, we have found that it is typically not necessary to add water to the compositions described herein. The water useful for hydrolysis of the silane groups may be adventitious water in the solvent or adsorbed to the surface of the substrate or may be present in the atmosphere to which the amino-functional compound and the polysiloxane are exposed.

In some embodiments, the amount of organic solvent in compositions according to the present disclosure and/or useful for practicing the present disclosure can make up the remainder of the weight after accounting for the other components described above. In some embodiments, the amount of organic solvent is at least 10%, 20%, 30%, 40%, 50%, 60%, 70%, 80%, 90%, 95%, 99%, or 99.5% by weight and can be up to 99.9% by weight or more, based on the total weight of the composition.

The present disclosure provides methods of making a treated article having a metal surface. The metal surface that may be treated according to the present disclosure may comprise any metal and/or metal alloy that is solid at room temperature. In some embodiments, the metal surface comprises at least one of chromium, chromium alloys, iron, aluminum, copper, nickel, titanium, zinc, tin, stainless steel, mild steel, and brass. An article to be treated may include layers of one or more of these metals and/or alloys of these metals.

In some embodiments, the metal surface treated as described in the present disclosure comprises a chromated surface such as a chromated steel surface. Chemical conversion coatings (e.g., chromate or phosphate coatings) can be used to improve the corrosion resistance and adhesion capabilities of some metals (e.g., galvanized steel, zinc, and aluminum). Chromating solutions, which are acidic and function by dissolving some of the surface metal of the substrate to be chromated, are specifically designed for the metal to be treated. Chromated surfaces may contain various levels of hexavalent chromium depending on the type of chromating solution.

In some embodiments, the metal surface treated according to the present disclosure comprises at least one of stainless steel or aluminum. The stainless steel that may be treated as described herein includes a variety of grades. For example, the article can have a surface of austenitic, ferritic, or martensitic stainless steel containing at least about 10 (in some embodiments, 11, 12, 13, 14, 15, 16, 17, 18, 19, or 20) percent by weight of chromium. When the chromium content in the stainless steel is at least about 10 percent by weight, the steel can generally readily be formed into a desired shape. Specific types of suitable stainless steels include 430, 304, and 316. Stainless steel generally forms a passivation layer of chromium(III) oxide on its surface. Stainless steel can be resistant to some types of surface treatments that are typically used to improve adhesion such as surface abrasion and is typically not treated with a chemical conversion coating as described above. While adhesion (e.g., of a coating) to some metals is improved by surface abrasion of the metal, stainless steel tends to work-harden under abrasive treatments.

In some embodiments, the metal surface treated according to the present disclosure is present on a part composed of a polymeric or composite material. According to some embodiments, the polymeric or composite material is selected from the group consisting of polyolefins (polypropylene, polyethylene, high density polyethylene, blends of polypropylene), polyamide 6 (PA6), acrylonitrile butadiene styrene (ABS), polycarbonate (PC), PC/ABS blends, polyvinyl chloride (PVC), polyamide (PA), polyurethane (PUR), thermoplastic elastomers (TPE), polyoxymethylene (POM), polystyrene, poly(methyl) methacrylate (PMMA), clear coats for vehicles, composite materials like fiber reinforced plastics, and any combinations or mixtures thereof. In some embodiments, the metal surface for use herein may be present on a chrome-plated part, in particular a part chrome-plated by a galvanization process, in particular electrolytical galvanization or hot-dip galvanization process, wherein the chrome-plated part includes any of the polymeric and composite materials described above.

Examples of articles having a metal surface that may be advantageously treated according to the method described herein include kitchen and bathroom faucets, taps, handles, spouts, sinks, drains, hand rails, towel holders, curtain rods, dish washer panels, refrigerator panels, stove tops, stove, oven, and microwave panels, exhaust hoods, grills, automotive wheels or rims, electronic devices (e.g., smartphones) and chemical reactors. Stainless steel articles that are treated according to the present disclosure include those having stainless steel surfaces in a wide range of thicknesses, depending on the application.

The method of the present disclosure includes treating the metal surface with a polysiloxane having at least one of a phosphate group or a phosphonate group. It is believed that the phosphate or phosphonate group can react with and/or interact with the metal surface to promote adhesion between the polysiloxane and the metal surface.

In some embodiments, the method according to the present disclosure includes treating the metal surface with a composition including the amino-functional compound having at least one silane group and polysiloxane having at least one of a phosphate group or a phosphonate group. Hydrolysis of at least some of the hydrolysable groups Y of the amino-functional compound having at least one silane group typically generates silanol groups, which participate in condensation reactions to form siloxanes. The water useful for hydrolysis may be added to the composition, may be adventitious water in the solvent or adsorbed to the surface of the substrate, or may be present in the atmosphere to which the amino-functional compound and the polysiloxane are exposed (e.g., an atmosphere having a relative humidity of at least 10%, 20%, 30%, 40%, or even at least 50%).

In some embodiments of the methods according to the present disclosure, the method includes treating the metal surface with a primer composition including the amino-functional compound having at least one silane group to provide a primed metal surface and subsequently treating the primed metal surface with a polysiloxane having at least one of a phosphate group or a phosphonate group. In the primer composition, the concentration of the amino-functional compound and any other components in the organic solvent may be chosen to provide a homogeneous primer composition. A primer composition useful for practicing the present disclosure typically includes from at least 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, or 0.5 percent by weight, up to 1, 1.5, or 2 percent by weight of at least one amino-functional compound, in some embodiments, secondary or tertiary amino-functional compound, based on the total weight of the primer composition. For example, the amount of an amino-functional compound in a primer composition may be in a range of from 0.01 to 2, 0.01 to 1, 0.05 to 2, 0.05 to 1, or from 0.1 to 1 percent by weight, based on the total weight of the primer composition. Lower or higher amounts of the amino-functional compound may also be useful and may be desirable for some applications.

When the amino-functional compound is used as a primer, it is believed that the amino group can react with and/or form a chelate with the metal surface. At least some of the hydrolysable Y groups in the Si(Y)ₚ(R²)₃₋ₚ groups are then hydrolyzed to form silanol groups. The water useful for hydrolysis may be added to the primer composition, may be adventitious water in the solvent or adsorbed to the surface of the substrate, or may be present in the atmosphere to which the amino-functional compound is exposed (e.g., an atmosphere having a relative humidity of at least 10%, 20%, 30%, 40%, or even at least 50%). Before the treatment composition is added, the primer composition is typically allowed to remain on the metal surface for a sufficient time to allow silanol groups to form. The primer composition typically is not allowed to remain on the metal surface for such a length of time that all of the silanol groups react to form siloxane bonds. When the amino-functional silane is used as a primer, it has been found that one to five hours at room temperature may be a time sufficient to allow silanol groups to form without allowing the formation of too many siloxane bonds. Also, it has been found that five to 60 minutes at an elevated temperature such as 100° C. to 150° C. may be a time sufficient to allow silanol groups to form.

In embodiments of the method in which the amino-functional compound is used as a primer, it is typically possible to analyze the treated article to find a layer rich in the amino-functional compound and a layer rich in the polysiloxane compounds, for example, using ESCA or other analytical techniques.

In some embodiments, the metal surface to be treated may be cleaned before treatment. It is typically desirable to remove foreign materials such as dust, oil, grease, and other contamination. Cleaning may be carried out, for example, with an organic solvent (e.g., a ketone such as acetone, an alcohol such as isopropanol, or an alkane such as heptane), with a sequence of organic solvents, with water, with a solution of sodium hydroxide (e.g., 2, 5, or 10 percent by weight aqueous sodium hydroxide), or with a combination thereof. The cleaning may be carried out at room temperature or at an elevated temperature (e.g., in a range from about 50° C. to about 100° C. or higher). Techniques for cleaning a metal surface include wiping, rinsing, sonicating, and heating at very high temperature (e.g., 400° C.). After cleaning, the metal surface of the substrate may be dried, for example, under a stream of air or nitrogen or at an elevated temperature. The metal surface can also be cleaned using plasma or corona treatment.

A wide variety of methods can be used to treat a metal surface with the composition according to the present disclosure and, in some embodiments, a primer composition disclosed herein (e.g., brushing, spraying, dipping, bar coating, wiping, rolling, spreading, or chemical vapor deposition). A metal surface can typically be treated with the composition (and, in some embodiments, primer composition) at room temperature (typically, about 15° C. to about 30° C. or about 20° C. to about 25° C.). Or the composition can be applied to surfaces that are preheated (e.g., at a temperature of 60° C. to 150° C.). Following application, the treated article can be dried and cured at ambient or elevated temperature (e.g., at 40° C. to 300° C., 50° C. to 150° C., or 75° C. to 140° C.) and for a time sufficient to dry (e.g., ten minutes at 140° C.). In some embodiments, repellent and durable surface treatments according to the present disclosure can be obtained upon treating an article and drying at ambient temperature (e.g., for up to 48 hours or 24 hours). Easy-to-clean articles prepared according to the present disclosure wherein the composition is dried typically no longer have organic solvent or water present on the surface.

In some embodiments, including any one of the above embodiments, the method of making an article having a metal surface further comprises subjecting at least the surface to an elevated temperature after treating the metal surface with the composition, in some embodiments, after the composition and after the primer composition.

Compositions according to the present disclosure may be applied to a metal surface either shortly after their preparation (e.g., up to one hour), or after standing at room temperature for a period of time (e.g., more than 1 hour, 3 to 8 hours, several days, or several weeks).

Compositions according to the present disclosure may be prepared from a concentrate (e.g., a concentrated solution of a polysiloxane having at least one of a phosphate or phosphonate group in organic solvent). The concentrate may be stable for several weeks (e.g., at least one, two, three, or six months) and may comprise the polysiloxane compound in an amount of at least 10, 20, 25, 30, or at least 40 percent by weight, based on the total weight of the concentrate. Concentrates may be diluted shortly before use, for example, with an organic solvent and optionally additional polysiloxane, the amino-functional compound, and, in some embodiments, water or acid.

In some embodiments, including any one of the above embodiments of the methods according to the present disclosure, the thickness of the treatment is less than 1 micrometer, typically less than 500 nanometers. In some embodiments, the thickness of the treatment is at least about 10, 20, 30, or 50 nanometers, up to about 100, 150, or 200 nanometers. Thin coatings made according to the methods disclosed herein typically and advantageously are transparent and do not change the visual appearance, thermal conductivity, or mechanical properties of the metal surface.

The easy-to-clean performance of the treated articles made by methods disclosed herein is typically measured by evaluating contact angles (e.g., of water) on the treated surface. In this application, water contact angles are measured at room temperature (e.g., about 25° C. to 30° C.) using equipment obtained from Kruss GmbH, Hamburg, Germany, and are usually measured several times to obtain an average measurement. In some embodiments of the methods disclosed herein, the treated metal surface has an initial static contact angle versus water of at least 80 (in some embodiments, at least 85, 80, 95, 97, 98, 100, 105, or 110) degrees. In these embodiments, “initial” refers to contact angles measured for the treated metal surface about 24 hours after treating the surface and before any abrading or wiping of the treated metal surface.

Metal surfaces treated according to the methods of the present disclosure typically provide durable easy-to-clean performance (i.e., the easy-to-clean performance is maintained after cleaning the surface several times). In this application, durability is measured by measuring contact angles (e.g., of water) of a treated metal plate before and after being subjected to abrasion. Abrasion is carried out by abrading the treated substrates on an abrasion tester (obtained from Erichsen GmbH & Co. KG, Hemer, Germany) and scrubbing for 4000 cycles with the yellow side of a sponge obtained from 3M Company, St. Paul, Minn. under the trade designation “SCOTCHBRITE”, which is water-wet. In some embodiments of the methods and articles disclosed herein, the treated metal surface has a static contact angle versus water of at least 75 (in some embodiments, at least 80, 85, 90, 95, 100, or 105) degrees after 4000 cycles of abrasion as described above.

The easy-to-clean performance of the treated articles made by methods disclosed herein is also measured by visually evaluating how a permanent marker wets out the treated surface (stain repellency), how easily the marker can be removed from the surface (ease of stain removal), and whether the mark remains visible on the surface (stain resistance). The durability of this easy-to-clean performance is measured before and after abrasion.

The treated articles made by methods disclosed herein may also provide fingerprint resistance, which may be measured by visually evaluating how a fingerprint marks the treated surface and how easily the fingerprint can be removed from the surface (ease of fingerprint removal). The durability of this easy-to-clean performance can be measured before and after abrasion.

The composition and method according to the present disclosure provides treated substrates with at least one of surprisingly high contact angles, high stain repellency, easy stain removal, or high stain resistance, even with very low concentration of the polysiloxane.

### Some Embodiments of the Disclosure

In a first embodiment, the present disclosure provides a method of making a treated article having a metal surface, the method comprising treating at least a portion of the metal surface with a composition comprising a polysiloxane functionalized with at least one of a phosphate or phosphonate group.

In a second embodiment, the present disclosure provides the method of the first embodiment, wherein the metal surface comprises at least one of chromium, a chromium alloy, iron, aluminum, copper, nickel, titanium, zinc, tin, stainless steel, mild steel, or brass.

In a third embodiment, the present disclosure provides the method of the first or second embodiment, further comprising treating the metal surface with a primer composition comprising an amino-functional compound having at least one silane group to provide a primed metal surface before treating the metal surface with the composition comprising the polysiloxane having at least one of a phosphate or phosphonate group.

In a fourth embodiment, the present disclosure provides the method of the third embodiment, wherein the primer composition further comprises organic solvent.

In a fifth embodiment, the present disclosure provides the method of the third or fourth embodiment, wherein the amino-functional compound is present in the primer composition in a range from 0.01 percent to 2 percent by weight, based on the total weight of the composition.

In a sixth embodiment, the present disclosure provides the method of any one of the first to fifth embodiments, wherein the composition further comprises an amino-functional compound having at least one silane group.

In a seventh embodiment, the present disclosure provides a composition comprising:

a polysiloxane having at least one of a phosphate or phosphonate group; and

an amino-functional compound having at least one silane group.

In an eighth embodiment, the present disclosure provides the method or composition of the sixth or seventh embodiment, wherein the amino-functional compound is present in the composition in a range from 0.01 percent to 2 percent by weight, based on the total weight of the composition.

In a ninth embodiment, the present disclosure provides the method or composition of any one of the third to eighth embodiments, wherein the amino-functional compound having at least one silane group is represented by formula:

(R⁶)₂N—[R⁴—Z′]ₐ—R⁴—[Si(Y)_{b}(R⁵)_{3-b}]

wherein

each R⁴ is independently arylene or alkylene interrupted or terminated by arylene;

each Z′ is independently —O— or —NR⁶—;

R is alkyl, aryl, or alkylenyl interrupted or terminated by aryl;

each R⁶ is independently hydrogen, alkyl, aryl, arylalkylenyl, or —R⁴—[Si(Y)ₚ(R⁵)₃₋ₚ];

each Y is independently hydroxyl, alkoxy, acetoxy, aryloxy, or halogen;

a is 0, 1, 2, or 3; and

b is 1, 2, or 3.

In a tenth embodiment, the present disclosure provides the method or composition of the ninth embodiment, wherein the amino-functional compound having at least one silane group is a secondary or tertiary amino-functional compound having at least two independently selected silane groups. In these embodiments, at least two independently selected —Si(Y)_{b}(R⁵)_{3-b} groups are present

In an eleventh embodiment, the present disclosure provides the method or composition of the tenth embodiment, wherein the amino-functional compound having at least one silane group is bis(3-trimethoxysilylpropyl)amine, N-methyl-bis(3-trimethoxysilylpropyl)amine, N,N′-bis[3-trimethoxysilylpropyl]-ethylenediamine, bis(3-triethoxysilylpropyl)amine, N-methyl-bis(3-triethoxysilylpropyl)amine, N,N′-bis[3-triethoxysilylpropyl]-ethylenediamine, or a combination thereof.

In a twelfth embodiment, the present disclosure provides the method or composition of any one of the first to eleventh embodiments, wherein the polysiloxane is present in the composition in an amount up to 0.5 percent, 0.4 percent, 0.3 percent, 0.2 percent, or 0.1 percent by weight, based on the total weight of the composition.

In a thirteenth embodiment, the present disclosure provides the method or composition of any one of the first to twelfth embodiments, wherein the composition further comprises organic solvent.

In a fourteenth embodiment, the present disclosure provides the method or composition of the thirteenth embodiment, wherein the organic solvent has a flashpoint greater than 40° C.

In a fifteenth embodiment, the present disclosure provides the composition or method of the thirteenth or fourteenth embodiment, wherein the organic solvent comprises a hydrocarbon solvent.

In a sixteenth embodiment, the present disclosure provides the composition or method of any one of the first to fifteenth embodiments, wherein the composition further comprises an acid catalyst.

In a seventeenth embodiment, the present disclosure provides the composition or method of any one of the first to fifteenth embodiments, wherein the composition is essentially free of an acid catalyst.

In an eighteenth embodiment, the present disclosure provides the composition or method of any one of the first to seventeenth embodiments, wherein the polysiloxane comprises first divalent units independently represented by formula:

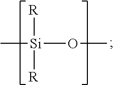

and at least one of
a second divalent unit represented by formula:

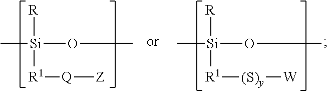

or
a terminal unit represented by formula —R¹-Q′-(Z)_{z} or —R¹—(S)_{y}—W;
wherein

each R is independently alkyl having up to 8 carbon atoms, haloalkyl having up to 8 carbon atoms, alkenyl having up to 8 carbon atoms, phenyl that is unsubstituted or substituted by at least one alkyl or alkoxy having up to 4 carbon atoms or halogen, or benzyl that is unsubstituted or substituted by at least one alkyl or alkoxy having up to 4 carbon atoms or halogen;

each R¹ is independently alkylene, arylene, or alkylene optionally interrupted or terminated by arylene;

each Q is independently a bond, alkylene, arylalkylene, alkylarylene, or arylene, wherein the alkylene, arylalkylene, alkylarylene, and arylene are optionally at least one of interrupted or terminated by at least one ether, thioether, amine, amide, ester, thioester, carbonate, thiocarbonate, carbamate, thiocarbamate, urea, thiourea, or a combination thereof;

each Q′ is independently a bond or divalent or multivalent alkylene, arylalkylene, alkylarylene, or arylene, wherein the divalent or multivalent alkylene, arylalkylene, alkylarylene, and arylene are optionally at least one of interrupted or terminated by at least one ether, thioether, amine, amide, ester, thioester, carbonate, thiocarbonate, carbamate, thiocarbamate, urea, thiourea, or a combination thereof;

y is 0 or 1;

z is 1 or 2;

W comprises divalent units represented by formula

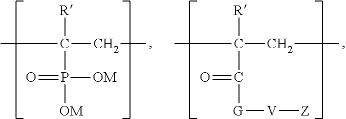

or a combination thereof;

each R′ is independently hydrogen or methyl;

each G is independently selected from the group consisting of —O—, —S—, and —N(R¹¹)—;

each R¹¹ is independently selected from the group consisting of hydrogen and alkyl having from 1 to 4 carbon atoms;

each V is independently alkylene that is optionally interrupted by at least one ether linkage or

amine linkage;

each Z is independently —P(O)(OM)₂ or —O—P(O)(OM)₂; and

each M is independently hydrogen, alkyl, trialkylsilyl, a counter cation, or a bond to the metal surface.

In a nineteenth embodiment, the present disclosure provides the composition or method of the eighteenth embodiment, wherein the polysiloxane comprises the second divalent unit represented by formula:

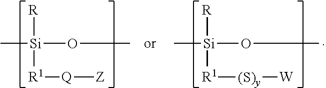

In a twentieth embodiment, the present disclosure provides the composition or method of the eighteenth or nineteenth embodiment, wherein the polysiloxane comprises the terminal unit represented by formula —R¹-Q′-(Z)_{z} or —R¹—(S)_{y}—W.

In a twenty-first embodiment, the present disclosure provides the composition or method of any one of the eighteenth to twentieth embodiments, wherein the polysiloxane comprises the second divalent unit represented by formula:

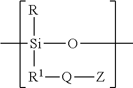

wherein

each R¹ is independently alkylene;

each Q is independently a bond or alkylene optionally at least one of interrupted or terminated by at least one ether or thioether; and

Z is —P(O)(OM)₂ or —O—P(O)(OM)₂, wherein each M is independently hydrogen, a counter cation, or a bond to the metal surface.

In a twenty-second embodiment, the present disclosure provides a composition or method of any one of the eighteenth to twentieth embodiments, wherein the polysiloxane comprises the second divalent unit represented by formula:

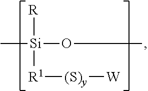

wherein

each R¹ is alkylene;

y is 1;

W comprises divalent units represented by formula

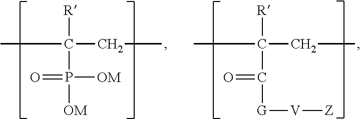

or a combination thereof;

each R′ is independently hydrogen or methyl;

each G is —O—;

V is alkylene;

each Z is independently —P(O)(OM)₂ or —O—P(O)(OM)₂; and

each M is independently hydrogen, a counter cation, or a bond to the metal surface.

In a twenty-third embodiment, the present disclosure provides the composition or method of the twenty-second embodiment, wherein W further comprises divalent units represented by formula —[CH₂—(R′) C (Si(X′)_{f}(R²)_{3-f})]— or

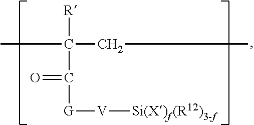

wherein

each R′ is independently hydrogen or methyl;

each G is independently —O—, —S—, or —N(R¹¹)—;

each R¹¹ is independently hydrogen or alkyl having from 1 to 4 carbon atoms;

each V is independently alkylene that is optionally interrupted by at least one ether linkage or

amine linkage;

each X′ is independently a hydrolyzable group;

each R¹² is independently alkyl, aryl, arylalkylenyl, or alkylarylenyl; and

f is 1, 2, or 3.

In a twenty-fourth embodiment, the present disclosure provides the composition or method of any one of the eighteenth to twenty-third embodiments, wherein the polysiloxane comprises one or two terminal units represented by formula —R¹-Q′-(Z)_{z};

wherein

each R¹ is independently alkylene;

each Q′ is independently a bond or divalent alkylene optionally at least one of interrupted or terminated by at least one ether or thioether;

Z is —P(O)(OM)₂ or —O—P(O)(OM)₂, wherein each M is independently hydrogen, a counter cation, or a bond to the surface; and

z is 1.

In a twenty-fifth embodiment, the present disclosure provides the composition or method of any one of the eighteenth to twenty-third embodiments, wherein the polysiloxane comprises one or two terminal units represented by formula —R¹—(S)_{y}—W, wherein

each R¹ is alkylene;

y is 1;

each W independently comprises divalent units represented by formula

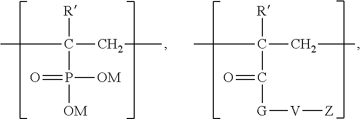

or a combination thereof;

each R′ is independently hydrogen or methyl;

each G is —O—;

V is alkylene;

each Z is independently —P(O)(OM)₂ or —O—P(O)(OM)₂; and

each M is independently hydrogen, a counter cation, or a bond to the metal surface.

In a twenty-sixth embodiment, the present disclosure provides the composition or method of the twenty-fifth embodiment, W further comprises divalent units represented by formula —[CH₂—(R′) C (Si(X′)_{f}(R²)_{3-f})]— or

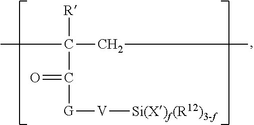

wherein

each R′ is independently hydrogen or methyl;

each G is independently —O—, —S—, or —N(R¹¹)—;

each R¹¹ is independently hydrogen or alkyl having from 1 to 4 carbon atoms;

each V is independently alkylene that is optionally interrupted by at least one ether linkage or

amine linkage;

each X′ is independently a hydrolyzable group;

each R¹² is independently alkyl, aryl, arylalkylenyl, or alkylarylenyl; and

f is 1, 2, or 3.

In a twenty-seventh embodiment, the present disclosure provides the composition or method of any one of the eighteenth to twenty-sixth embodiments, wherein at least 80 percent of the R groups are methyl.

In a twenty-eighth embodiment, the present disclosure provides the composition or method of any one of the first to twenty-seventh embodiments, wherein the polysiloxane has a molecular weight of at least 900 grams per mole.

In a twenty-ninth embodiment, the present disclosure provides a polysiloxane comprising first divalent units independently represented by formula:

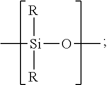

and at least one of
a second divalent unit represented by formula:

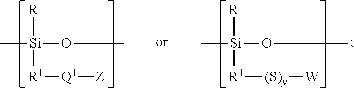

or
a terminal unit represented by formula —R¹-Q′-Z or —R¹—(S)_{y}—W;
wherein

each R is independently alkyl having up to 8 carbon atoms, haloalkyl having up to 8 carbon atoms, alkenyl having up to 8 carbon atoms, phenyl that is unsubstituted or substituted by at least one alkyl or alkoxy having up to 4 carbon atoms or halogen, or benzyl that is unsubstituted or substituted by at least one alkyl or alkoxy having up to 4 carbon atoms or halogen;

each R¹ is independently alkylene, arylene, or alkylene optionally interrupted or terminated by arylene;

each Q¹ is independently alkylene, arylalkylene, alkylarylene, or arylene, wherein the alkylene, arylalkylene, alkylarylene, and arylene are at least one of interrupted or terminated by at least one amine, amide, ester, thioester, carbonate, thiocarbonate, carbamate, thiocarbamate, urea, thiourea, or a combination thereof;

y is 0 or 1;

each W independently comprises divalent units represented by formula

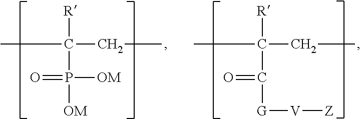

or a combination thereof;

each R′ is independently hydrogen or methyl;

each G is independently selected from the group consisting of —O—, —S—, and —N(R¹¹)—;

each R¹¹ is independently selected from the group consisting of hydrogen and alkyl having from 1 to 4 carbon atoms;

each V is independently alkylene that is optionally interrupted by at least one ether linkage or amine linkage;

each Z is independently —P(O)(OM)₂ or —O—P(O)(OM)₂; and

each M is independently hydrogen, alkyl, trialkylsilyl, or a counter cation.

In a thirtieth embodiment, the present disclosure provides the polysiloxane of the twenty-ninth embodiment, wherein the polysiloxane comprises the second divalent unit represented by formula:

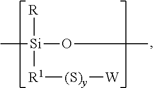

wherein

each R¹ is alkylene;

y is 1;

W comprises divalent units represented by formula

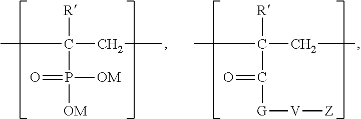

or a combination thereof;

each R′ is independently hydrogen or methyl;

each G is —O—;

V is alkylene;

each Z is independently —P(O)(OM)₂ or —O—P(O)(OM)₂; and

each M is independently hydrogen or a counter cation.

In a thirty-first embodiment, the present disclosure provides the polysiloxane of the twenty-ninth or thirtieth embodiment, wherein the polysiloxane comprises one or two terminal units represented by formula —R¹—(S)_{y}—W, wherein

each R¹ is alkylene;

y is 1;

W comprises divalent units represented by formula

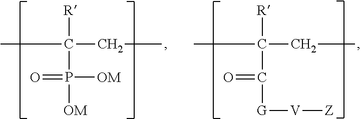

or a combination thereof;

each R′ is independently hydrogen or methyl;

each G is —O—;

V is alkylene;

each Z is independently —P(O)(OM)₂ or —O—P(O)(OM)₂; and

each M is independently hydrogen or a counter cation.

In a thirty-second embodiment, the present disclosure provides the polysiloxane of any one of the twenty-ninth to thirty-first embodiments, wherein W further comprises divalent units represented by formula —[CH₂—(R′) C (Si(X′)_{f}(R¹²)_{3-f})]— or

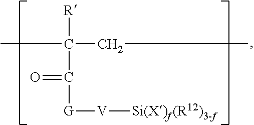

wherein

each R′ is independently hydrogen or methyl;

each G is independently —O—, —S—, or —N(R¹¹)—;

each R¹¹ is independently hydrogen or alkyl having from 1 to 4 carbon atoms;

V is alkylene that is optionally interrupted by at least one ether linkage or amine linkage;

each X′ is independently a hydrolyzable group;

each R¹² is independently alkyl, aryl, arylalkylenyl, or alkylarylenyl; and

f is 1, 2, or 3.

In a thirty-third embodiment, the present disclosure provides the polysiloxane of the twenty-ninth embodiment, wherein the polysiloxane comprises the second divalent unit represented by formula:

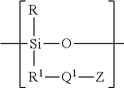

wherein

each R¹ is independently alkylene;

each Q¹ is independently alkylene at least one of interrupted or terminated by amine, ester, or a combination thereof; and

each Z is independently —P(O)(OM)₂.

In a thirty-fourth embodiment, the present disclosure provides the polysiloxane of the twenty-ninth or thirty-third embodiment, wherein the polysiloxane comprises one or two terminal units represented by formula —R¹-Q′-Z, wherein

each R¹ is independently alkylene;

each Q¹ is independently alkylene at least one of interrupted or terminated by amine, ester, or a combination thereof; and

each Z is independently —P(O)(OM)₂.

In a thirty-fifth embodiment, the present disclosure provides the polysiloxane of the thirty-fourth embodiment, wherein the polysiloxane comprises two terminal units represented by formula —R¹-Q′-Z, wherein

each R¹ is independently alkylene;

each Q¹ is independently alkylene at least one of interrupted or terminated by amine, ester, or a combination thereof; and

each Z is independently —P(O)(OM)₂.

In a thirty-sixth embodiment, the present disclosure provides the polysiloxane of any one of the twenty-ninth to thirty-fifth embodiments, wherein at least 80 percent of the R groups are methyl.

In a thirty-seventh embodiment, the present disclosure provides the polysiloxane of any one of the twenty-ninth to thirty-sixth embodiments, wherein the polysiloxane has a molecular weight of at least 1000 grams per mole.

The present disclosure is further illustrated by the following examples. These examples are merely for illustrative purposes only and are not meant to be limiting on the scope of the appended claims. All parts and percentages are by weight unless otherwise indicated.

### EXAMPLES

### Test Methods and Procedures:

Static Water Contact Angle Measurement (WCA-1) The static water contact angle was measured on dried treated test panels before and optionally after being subjected to Abrasion Testing. Measurements were made using deionized water, filtered through a filtration system obtained from Millipore Corporation (Billerica, Mass.). The measurements were done using a DSA100 Contact Angle Analyzer (commercially available from Kruss GmbH, Germany). The water contact angle was measured on drops having a volume of 5 μL, 30 seconds after deposition. The values of the contact angles are the averages of measurements on at least three drops and are reported in degrees (°).

### Water Contact Angle Measurement (WCA-2)

The contact angle analysis WCA-2 was performed with a model #500-F1 advanced goniometer (from Ramé-hart Instrument Co., Mountain Lakes, N.J.,) using MilliQ water as the testing fluid. The values of the contact angles are the averages of measurements on at least three drops and are reported in degrees (°).

### Static Oil Contact Angle Measurement (OCA)

The static oil contact angle was measured using a model #500-F1 advanced goniometer (from Ramé-hart Instrument Co.) by applying drops of peanut oil. The values of the contact angles are the averages of measurements on at least three drops and are reported in degrees (°).

### Mechanical Wet Abrasion Testing

Abrasion tests were performed on treated test panels, using a Scrub Resistance Tester (commercially available from Erichsen GmbH, Germany) during 4000 cycles with no force applied. The cloth used for the abrasion cycles was the yellow side of a “SCOTCHBRITE” sponge (commercially available from the 3M Company, USA) wetted with deionized water.

### Stain Release Test

a. Stain Removal Test (ST)

A marker stain (using a permanent marker, commercially available under tradename Artline 100N) with a width of 5-10 mm and a length of 30-40 mm was applied onto treated and untreated test panels having a metal surface. The marked test material was then dried for 30 minutes at room temperature, before carrying out the stain removal procedure. The ease of stain removal was evaluated by rubbing the stained surface for 20 seconds with a dry cotton cloth. The stain removal was rated on a scale ranging from 1 to 3, wherein 1 means “easy removal”, 2: “medium removal and 3: “difficult removal”.

b. Stain Resistance Test (SR)

After the stain was removed by rubbing for 20 seconds with a dry cotton cloth (stain removal test), the residual stain was visually rated according to the 8-point 3M Stain Release scale, wherein: 1=completely stained, 8=no stain left.

### 180° Peel Adhesion

The release properties of treated and untreated stainless steel test substrates were optionally also evaluated by measuring the 180° peel adhesion using a Rycobel peel tester, available from Thwing-Albert Instruments, Co. A piece of “3M SCOTCHLITE ELECTROCUT FILM 1170”, having a width of 1 inch, was applied to treated and untreated stainless steel substrates. The tape was rolled over 6 times with a stainless steel roll having 2 kg weight. After storing the samples for 24 hours at room temperature, the 180° peel adhesion was tested using a velocity of 0.3 m/min. The results were expressed in Newton/inch (N/inch) and were the average of 3180° peel adhesion measurements.

### Oil Repellency Tests

a. Peanut Oil Retraction Test (OR)

Test panels were equilibrated to room temperature before evaluation. A 0.5 mL aliquot of 100% peanut oil (Planters brand obtained from the Kraft Heinz Company) was applied to the coated surface of the test panel using a disposable pipette. A 254 mm wide polyurethane foam applicator was used spread the peanut oil over the entire surface while the panels were laid flat on a horizontal surface. The samples were left at room temperature for 15 minutes for the oil to retract and equilibrate. The retraction of the peanut oil was measured by analyzing an image of the oil covered surface area using the open source image processing software ImageJ (NIH, Bethesda, Md.; https://imagej.nih.gov/ij/). The results are reported in Table 18 as the percentage of the test panel surface covered with peanut oil, where 100% represents peanut oil completely covering the test panel surface.

b. Peanut Oil Travel Time Test

A test sample was prepared by adding three drops of 100% peanut oil (Planters brand obtained from the Kraft Heinz Company) at one edge of a coated stainless-steel test panel. The drops were added at the same spot on the surface to create a single large drop. The test panel was then placed at a 20° angle on a support ramp and the time for the drop to travel 5 cm was measured in seconds. The tests were conducted at room temperature. The test was repeated three times, and the mean travel time results (n=3) are reported in Table 18.

### Test Panels Having a Metal Surface

Stainless steel panels (Type 1.403 IIID; available from Rocholl GmbH, Germany) having a dimension of 125 mm×75 mm×2 mm.

Stainless steel panels (304C, deburred; available from McMaster Carr, Elmhurst, Ill.) having a dimension of 127 mm×50 mm×2 mm.

Chrome plated ABS test substrates (available from HSO GmbH, Solingen, Germany) having a dimension of 100 mm×50 mm×2 mm.

Aluminum test substrates (“ALU 300”, obtained from Hertel Holding B.V) having a dimension of 125 mm×75 mm×1 mm.

MATERIALS In the examples, the following raw materials are used:

| Raw Materials- | | |
|---|---|---|
| Trade Name | Description | Obtainable from |
| HEMAPHOS | HEMA-phosphate: | ESSTECH Inc. |
| | (HO)₂—P(O)—OCH₂CH₂O—CO—C(CH₃)═CH₂ | |
| VPA | Vinylphosphonic acid | SIGMA-ALDRICH |
| KF-2001 | polydimethylsiloxane with mercapto side | SHIN-ETSU |
| | chains (Eq. W. 1900) | |
| X-22-167B | α,ω-polydimethylsiloxane dithiol (Eq.W. 1700) | SHIN-ETSU |
| Wacker IM11 | α,ω-polydimethylsiloxane carbinol with Mₙ~1000 | WACKER |
| Wacker IM15 | α,ω-polydimethylsiloxane carbinol with Mₙ~4000 | WACKER |
| V-59 | Azo initiator | WACKO Ind |
| BTMSPA | bis(trimethoxysilyl propyl) amine, NH[(CH₂)₃Si(OCH₃)₃]₂ | MOMENTIVE |
| MAPTMS | 3-methacryloxypropyl trimethoxysilane | SIGMA-ALDRICH |
| PnB | Dowanol PnB, Propyleneglycol n-butyl ether | DOW |
| DPM | Dowanol DPM, Dipropyleneglycol monomethyl ether | DOW |
| MCR-A11 | α-monoaminopropyl polydimethylsiloxane with Mₙ~2000 | GELEST |
| | α,ω-diaminopropyl polydimethylsiloxane with Mₙ~1000 | 3M Company |
| | Hydroxyethylphosphonate dimethyl ester | TCI |
| TMSBr | Bromotrimethylsilane | ALFA AESAR |
| DMAP | 4-Dimethylaminopyridine | ALFA AESAR |
| TEA | Triethylamine | EMD |
| | Acryloyl chloride | SIGMA-ALDRICH |

Synthesis of Polysiloxanes Functionalized with at Least One of a Phosphate or Phosphonate Group:

### Polydimethylsiloxane (Mₙ˜4000) Phosphate Acid (SiPhat1)

A 250 ml 3-neck flask equipped with a dropping funnel, magnetic stirrer and calcium chloride tube, was charged with Phosphoryl chloride (2.25 g; 14.7 mmole) and ethylacetate (52.1 g). Triethyl amine (4.45 g; 44.1 mmole) and Wacker IM15 diol (28.00 g; 7.0 mmole) were added sequentially and dropwise via the dropping funnel. After stirring for 6 hours, the reaction mixture was transferred to a separatory funnel and mixed with 1N HCl (170 g) and ethylacetate (170 g). After phase separation, the organic phase was washed twice with 2N HCl (2×100 g). The organic phase was dried over anhydrous sodium sulfate and filtered. After solvent removal with a Büchi rotary evaporator using waterjet vacuum, the reaction product was obtained as a viscous yellow liquid. The product structure was confirmed via NMR spectroscopy. The product included divalent units represented by the formula I, wherein R is methyl, and two terminal units represented by formula —R¹-Q′-(Z)_{z}, wherein R¹ is propylene, Q′ is a bond, z is 1, and Z is —O—P(O)(OM)₂, wherein each M is hydrogen.

### Polydimethylsiloxane (Mₙ˜1000) Phosphate Acid (SiPhat2)

Phosphoryl chloride (5.78 g; 37.8 mmole) and ethylacetate (52.9 g) were charged into a 250 ml 3-neck flask equipped with a dropping funnel, magnetic stirrer and calcium chloride tube. Triethyl amine (11.45 g; 113.4 mmole) and Wacker IM11 diol (18.00 g; 18.0 mmole) were added sequentially and dropwise via the dropping funnel. The same reaction and work-up procedure were used as for SiPhat1. SiPhat2 is a polysiloxane functionalized with 2 terminal phosphate groups having a similar structure as SiPhat1, but with a lower molecular weight.

### Polydimethylsiloxane Phosphonate Acid (SiPhon1)

A 100 ml polymerization bottle was charged respectively with KF-2001 (19.00 g; 10.0 meq.), VPA (1.08 g; 10.0 meq.), ethylacetate (20.08 g) and 0.060 g (0.30% on solids) V-59 azo-initiator. The bottle was degassed with waterjet vacuum, followed by breaking the vacuum with nitrogen atmosphere. This procedure was repeated 3 times. The polymerization bottle was run for 20 hours in a preheated Launder-0-meter at 70° C. After cooling, 0.060 g (0.30% on solids) V-59 was added, the bottle was again degassed and covered with nitrogen atmosphere. The polymerization bottle was then run for another 8 hours at 70° C., yielding a semi-viscous milky solution containing 50% polymer solids.

After solvent removal with a Büchi rotary evaporator using waterjet vacuum, the reaction product was obtained as a white paste. The structure SiPhon1, obtained as major compound of the polymerization mixture, was confirmed via NMR spectroscopy. The product included divalent units represented by the formula I, wherein R is methyl, and at least one second divalent unit represented by formula II, wherein R¹ is propylene, Q is —S—CH₂CH₂—, Z is —P(O)(OM)₂, and each M is hydrogen

Polydimethylsiloxane Phosphonate Acid (SiPhon2)

A 100 ml polymerization bottle was charged respectively with X-22-167B (19.55 g; 11.5 meq.), VPA (1.24 g; 11.5 meq.), IPA (20.79 g) and 0.062 g V-59 azo-initiator. The bottle was degassed with waterjet vacuum, followed by breaking the vacuum with nitrogen atmosphere. This procedure was repeated 3 times. The polymerization bottle was run for 20 hours in a preheated Launder-O-meter at 70° C. After cooling, 0.062 g V-59 was added, the bottle was again degassed and covered with nitrogen atmosphere. The polymerization bottle was then run for another 8 hours at 70° C., yielding a clear semi-viscous solution containing 50% polymer solids. The product structure was confirmed via NMR spectroscopy.

The product included divalent units represented by the formula I, wherein R is methyl and terminal unit represented by formula —R¹-Q′-Z, wherein R¹ is propylene, Q′ is —S—CH₂CH₂—, Z is —P(O)(OM)₂, wherein each M is hydrogen.

Further polysiloxanes functionalized with a phosphonate group were prepared using essentially the same procedure as outlined for the synthesis of SiPhon1, but using isopropylalcohol instead of ethylacetate and using the ingredients as given in Table 1.

A summary of all polysiloxanes functionalized with at least one phosphonate group can be found in Table 1 (amounts expressed in equivalents).

TABLE 1
Composition of polysiloxanes functionalized
with a phosphonate group (equivalent ratio)

| | KF-2001 | X-22-167B | VPA | MAPTMS | % solids |
|---|---|---|---|---|---|
| SiPhon1 | 1 | | 1 | | 50 |
| SiPhon2 | | 1 | 1 | | 50 |
| SiPhon3 | 1 | | 3 | | 50 |
| SiPhon4 | | 1 | 3 | | 50 |
| SiPhon5 | | 1 | 2 | 1 | 30 |

SiPhon3 was a polysiloxane comprising divalent units represented by formula I, wherein R is methyl, and at least at least one second divalent unit represented by formula III, wherein R is CH₃, R¹ is propylene, y is 1, and W includes divalent units represented by formula IV, wherein R′ is H, and each M is hydrogen. SiPhon4 was a polysiloxane comprising divalent units represented by formula I, wherein R is methyl, and terminal units represented by formula —R¹—(S)_{y}—W wherein R¹ is propylene, y is 1, W includes divalent units represented by formula IV, wherein R′ is H and each M is hydrogen. SiPhon5 is a polysiloxane comprising divalent units represented by the formula I, wherein R is methyl and at least one terminal unit represented by formula —R¹—(S)_{y}—W wherein R¹ is propylene, y is 1, W includes divalent units represented by formula IV, wherein R′ is H and each M is hydrogen, and at least one divalent unit represented by formula VI, wherein R′ is CH₃, G is —O—, V is propylene, and Si(X′)_{f}(R¹²)_{3-f} is trimethoxysilyl.

Polydimethylsiloxane Phosphate Acid (SiPhat3)

Polydimethylsiloxane phosphate acid (SiPhat3) was prepared essentially according to the procedure as outlined for SiPhon1, but using KF-2001/HEMAPHOS/MAPTMS in a ratio 1:2:1 in a 30% solids reaction. The product includes divalent units represented by the formula I, wherein R is methyl, at least one second divalent unit represented by formula III, wherein R is CH₃, R¹ is propylene, y is 1, and W includes divalent units represented by formula V, wherein R′ is CH₃, G is —O—, V is ethylene, Z is O—P(O)(OM)₂ and each M is hydrogen, and at least one divalent unit represented by formula VI, wherein R′ is CH₃, G is —O—, V is propylene, and Si(X′)_{f}(R¹²)_{3-f} is trimethoxysilyl.

Preparation of the Treating Compositions:

Treatment compositions were prepared by adding a polysiloxane functionalized with at least one of a phosphate or phosphonate group, and optionally an amino-functional silane or other additives to a solvent in amounts, as given in the examples, to obtain the required concentrations. The formulations were gently mixed to obtain homogeneous solutions.

Application and Curing Procedure:

Substrate Cleaning:

All test panels were cleaned before testing (“Reference examples”) or before treating the panels with a composition according to the disclosure (“examples”).

Stainless-steel test panels were cleaned by wiping once with methyl ethyl ketone (MEK), once with n-heptane and again once with MEK, using a soaked Kimtech Science™ Precision Wipe type 7552 (available from Kimberly-Clark) and left to dry at 20° C. for at least 1 hour.

Chrome-plated ABS test panels were cleaned by wiping once with IPA, using a soaked Kim wipe (available from Kimberly-Clark) and left to dry at 20° C. for at least 1 hour.

Aluminum panels were cleaned by wiping once with IPA, using a soaked with Kim wipe (available from Kimberly-Clark) and then left to dry at 20° C. for at least 1 hour.

Dip Coating Application:

Manual Dipping

The stainless steel test panels were immersed horizontally into the treatment compositions for 15 seconds. The treated samples were taken out of the bath and dried vertically at room temperature for 1 minute, then at 85° C. for 10 minutes. Alternatively, as indicated in the examples, the treated samples were dried at room temperature.

With RDC-21 Equipment

The stainless steel test panels were treated by using an RDC-21 dip-coater available from Bungard (Germany). Hereby the test panels were immersed vertically into the treatment formulations at a speed of 300 mm/min. Once the parts were fully immersed, they were held in the bath for 1 minute.

The samples were taken out of the bath at a speed of 300 mm/min and dried vertically at room temperature for 1 minute, then dried vertically at 85° C. for 10 min. Alternatively, as indicated in the examples, the treated samples were dried at room temperature overnight.

Wipe Application

The treatment composition (0.5 ml) was pipetted onto a Kim wipe (type 7552/055111, available from Kimberly-Clark), which was then used to wipe the surface of the test panel (wiping once). The treated samples were dried a indicated in the examples.

### Example EX-1 and Reference Example REF-1

In Example EX-1 a stainless steel test panel was treated with a 0.1% solution of a polysiloxane functionalized with a phosphate group (SiPhat1) in IPA. The treatment was done by wipe application. The treated test panel was dried at room temperature overnight. The stain release (using an Artline blue permanent marker) and the 180° peel adhesion were measured according to the methods described above. The results are recorded in Table 2.

TABLE 2

| | | Stain marker: | | | |
|---|---|---|---|---|---|
| | | Artline Blue | | | |
| | Treatment | | Ease | | 180° |
| | composition | Stain | stain | Stain | Peel |
| Example | in IPA | repellency | removal | resistance | (N/inch) |
| EX-1 | 0.1% SiPhat1 | 2 | 1 | 8 | 4.1 |
| REF-1 | Untreated | 5 | 3 | 2 | 23.6 |

Treating a stainless steel panel with a polysiloxane functionalized with a phosphate group improves its stain release considerably.

### Examples EX-2 to EX-10 and Reference Example REF-2

In Examples EX-2 to EX-9, stainless steel test panels were treated with polysiloxanes functionalized with a phosphate group (SiPhat1 to SiPhat3), optionally in combination with an amino-functional silane (BTMSPA). The treatment formulations were prepared in a solvent mixture of 80% PnB and 20% DPM. The materials used and their concentration can be found in Table 3.

The stainless steel test panels of examples EX-3, EX-4, EX-7, EX-8 and EX-10 were dip coated manually in the formulation baths containing both polysiloxane functionalized compound and amino-functional silane. The treated panels were dried for 10 minutes at 85° C.

The stainless steel test panels of examples EX-5 and EX-9 were treated in 2 steps. In a first step, the panels were manually dip coated in a bath containing the amino-functional silane, then dried at 85° C. In a second step, the panels were dipped in a bath containing the polysiloxane functionalized compound, followed by drying at 85° C. for 10 min.

The static contact angles (WCA-1) and stain release properties, before and after wet abrasion, were measured according to the methods described above. The results are recorded in Tables 3 and 4.

TABLE 3
Treatment formulation and WCA-1 measurement

| | Treatment composition (%) | | | | | |
|---|---|---|---|---|---|---|
| | PnB/DPM (80/20) | | | IPA | WCA-1 (°) | |
| Example | SiPhat1 | SiPhat2 | BTMSPA | SiPhat3 | Initial | After abrasion |
| EX-2 | 0.10 | — | — | — | 85 | 93 |
| EX-3 | 0.05 | — | 0.03 | — | 101 | 93 |
| EX-4 | 0.10 | — | 0.03 | — | 100 | 93 |
| EX-5 | 0.10 | — | 0.09 | — | 103 | 94 |
| EX-6 | — | 0.10 | — | — | 83 | 87 |
| EX-7 | — | 0.05 | 0.03 | — | 97 | 90 |
| EX-8 | — | 0.10 | 0.03 | — | 97 | 90 |
| EX-9 | — | 0.10 | 0.09 | — | 92 | 90 |
| EX-10 | — | — | — | 0.1 | 93 | 90 |
| REF-2 | — | — | — | — | 38 | NA |

Note:
NA: not available

TABLE 4
Stain release properties

| | Stain release Artline Blue | | | | | |
|---|---|---|---|---|---|---|
| | Initial | | | After wet abrasion | | |
| | | Ease | | | Ease | |
| | Stain | stain | Stain | Stain | stain | Stain |
| Example | repellency | removal | resistance | repellency | removal | resistance |
| EX-2 | 1 | 1 | 8 | 3 | 1 | 8 |
| EX-3 | 1 | 1 | 8 | 1 | 1 | 8 |
| EX-4 | 1 | 1 | 8 | 1 | 1 | 8 |
| EX-5 | 1 | 1 | 8 | 1 | 1 | 8 |
| EX-6 | 2 | 1 | 8 | 4 | 1 | 8 |
| EX-7 | 2 | 1 | 8 | 2 | 1 | 8 |
| EX-8 | 2 | 1 | 8 | 3 | 2 | 8 |
| EX-9 | 1 | 1 | 8 | 2 | 2 | 8 |
| EX-10 | 4 | 2 | 8 | 5 | 3 | 4 |
| REF-2 | 5 | 3 | 1 | 5 | 3 | 3 |

As shown in Tables 3 and 4, the treatment compositions according to the present disclosure provide improved overall release properties as reflected in higher WCA values and improved stain release properties against permanent Artline Blue marker on stainless steel, when compared to uncoated substrates.

### Examples EX-11 to EX-15 and Reference Example REF-3

In Examples EX-11 to EX-15 stainless steel test panels were treated with 0.1% solutions of polysiloxanes functionalized with a phosphonate group (SiPhon1 to SiPhon5 respectively) in IPA. The treatment was done by manual dip coating. The treated test panels were dried either 24 hours at room temperature or 10 min at 85° C. The static contact angles (WCA-1) and stain release properties, before and after wet abrasion, were measured according to the methods described above. The composition of the treatment baths and the test results are recorded in Tables 5 and 6.

TABLE 5

| | Treatment | WCA-1 (°) | | WCA-1 (°) | |
|---|---|---|---|---|---|
| | Composition | Drying 24 hrs RT | | Drying 10 min 85° C. | |
| Example | in IPA | Initial | Abrasion | Initial | Abrasion |
| EX-11 | 0.1% SiPhon1 | 88 | 89 | 92 | 93 |
| EX-12 | 0.1% SiPhon2 | 94 | 88 | 92 | 90 |
| EX-13 | 0.1% SiPhon3 | 95 | 84 | 95 | 88 |
| EX-14 | 0.1% SiPhon4 | 92 | 87 | 95 | 91 |
| EX-15 | 0.1% SiPhon5 | 93 | 91 | 93 | 90 |
| REF-3 | Untreated | 51 | 51 | 51 | 51 |

TABLE 6

| | | Stain release Artline Blue | | | | | |
|---|---|---|---|---|---|---|---|
| | | Initial | | | After wet abrasion | | |
| | | | Ease | | | Ease | |
| | Drying | Stain | stain | Stain | Stain | stain | Stain |
| Example | condition | repellency | removal | resistance | repellency | removal | resistance |
| EX-11 | 24 hrs RT | 1 | 1 | 8 | 4 | 3 | 8 |
| | 10 min 85° C. | 2 | 1 | 8 | 1 | 1 | 8 |
| EX-12 | 24 hrs RT | 2 | 1 | 8 | 4 | 2 | 8 |
| | 10 min 85° C. | 2 | 1 | 8 | 4 | 2 | 8 |
| EX-13 | 24 hrs RT | 2 | 1 | 8 | 5 | 3 | 8 |
| | 10 min 85° C. | 1 | 1 | 8 | 4 | 3 | 8 |
| EX-14 | 24 hrs RT | 2 | 1 | 8 | 5 | 2 | 8 |
| | 10 min 85° C. | 1 | 1 | 8 | 4 | 3 | 8 |
| EX-15 | 24 hrs RT | 3 | 1 | 8 | 3 | 2 | 8 |
| | 10 min 85° C. | 2 | 1 | 8 | 4 | 1 | 8 |
| REF-3 | Untreated | 5 | 3 | 2 | 5 | 3 | 2 |

As can be seen from the results, heating the treated substrate may be advantageous, but is not required to obtain good stain repellency and resistance properties.

### Examples EX-16 to EX-20

Examples EX-16 to EX-20 were made with the same treating compositions as given in examples EX-11 to EX-15, but the stainless steel panels were treated by wipe application. The treated substrates were dried at 85° C. during 10 minutes. The static contact angles (WCA-1) and stain release properties, before and after wet abrasion, were measured according to the methods described above. The composition of the treatment baths and the test results are recorded in Tables 7 and 8.

TABLE 7

| | Treatment | | |
|---|---|---|---|
| | Composition | WCA-1 (°) | |
| Example | in IPA | Initial | Abrasion |
| EX-16 | 0.1% SiPhon1 | 89 | 88 |
| EX-17 | 0.1% SiPhon2 | 86 | 79 |
| EX-18 | 0.1% SiPhon3 | 90 | 81 |
| EX-19 | 0.1% SiPhon4 | 91 | 82 |
| EX-20 | 0.1% SiPhon5 | 82 | 75 |

TABLE 8

| | Stain release Artline Blue | | | | | |
|---|---|---|---|---|---|---|
| | Initial | | | After wet abrasion | | |
| | | Ease | | | Ease | |
| | Stain | stain | Stain | Stain | stain | Stain |
| Example | repellency | removal | resistance | repellency | removal | resistance |
| EX-16 | 1 | 1 | 8 | 5 | 1 | 8 |
| EX-17 | 1 | 1 | 8 | 4 | 3 | 8 |
| EX-18 | 1 | 2 | 8 | 4 | 3 | 8 |
| EX-19 | 1 | 1 | 8 | 5 | 3 | 8 |
| EX-20 | 1 | 3 | 8 | 5 | 3 | 4 |

### Examples EX-21 to EX-24 and Reference Example REF-4

In Examples EX-21 to EX-24 stainless steel test panels were treated with 0.1% solutions of polysiloxanes functionalized with a phosphonate group (SiPhon1 to SiPhon4 respectively) in IPA. The treatment was done by wipe application. The treated test panels were dried overnight at room temperature. The stain release properties and 180° peel values were measured according to the methods described above. The composition of the treatment baths and the test results are recorded in Table 9.

TABLE 9

| | | Stain marker: | | | |
|---|---|---|---|---|---|
| | Treatment | Artline Blue | | | 180° |
| | composition | Stain | Ease | Stain | peel |
| Example | in IPA | repellency | removal | resistance | (N/inch) |
| EX-21 | 0.1% SiPhon1 | 1 | 1 | 8 | 2.3 |
| EX-22 | 0.1% SiPhon2 | 2 | 1 | 8 | 5.4 |
| EX-23 | 0.1% SiPhon3 | 2 | 1 | 8 | 3.6 |
| EX-24 | 0.1% SiPhon4 | 2 | 1 | 8 | 4.8 |
| REF-4 | Untreated | 5 | 3 | 2 | 23.6 |

As shown in Table 9, stainless steel substrates treated with compositions according to the present disclosure not only have much better stain release properties against Artline Blue stain marker, but also much lower 1800 peel values.

### Examples EX-25 to EX-28 and Reference Example REF-5

In Examples EX-25 to EX-28, stainless steel test panels were treated with a polysiloxane functionalized with a phosphonate group (SiPhon1), optionally in combination with an amino-functional silane (BTMSPA). The treatment formulations were prepared in a solvent mixture of 80% PnB and 20% DPM. The materials used and their concentration can be found in Table 10.

The stainless steel test panels of Examples 25 and 26 were dip coated manually in a treatment bath containing both polysiloxane functionalized compound and amino-functional silane. The treated panels were dried for 10 minutes at 85° C.

The stainless steel test panels of Example 27 was treated in 2 steps. In a first step, the panel was manually dip coated in a bath containing the amino-functional silane, then dried at 85° C. In a second step, the panels were dipped in a bath containing the polysiloxane functionalized compound, followed by drying at 85° C. during 10 min.

The static water contact angles (WCA-1) and stain release properties, before and after wet abrasion, were measured according to the methods described above. The results are recorded in Tables 10 and 11.

TABLE 10

| | Treatment Composition | WCA-1 (°) | |
|---|---|---|---|
| Example | in PnB/DPM (80/20) | Initial | Abrasion |
| EX-25 | 0.10% SiPhon1 | 87 | 90 |
| EX-26 | 0.05% SiPhon1 + 0.03% BTMSPA | 98 | 90 |
| EX-27 | 0.10% SiPhon1 + 0.03% BTMSPA | 101 | 91 |
| EX-28 | 1) 0.09% BTMSPA + 2) 0.10% SiPhon1 | 101 | 92 |
| REF-5 | Untreated | 38 | NA |

Note:
NA: not available

As shown in Table 10, Example EX-26, a synergy is observed for the combination of polysiloxane functionalized with a phosphonate (SiPhon1) and an amino-functional silane (BTMSPA). An improved water contact angle value is obtained although less active material was applied.

A combination or pre-coating with amino-functional silane in general increases the (initial) water contact angle of the treated substrate.

TABLE 11

| | Stain release Artline Blue | | | | | |
|---|---|---|---|---|---|---|
| | Initial | | | After wet abrasion | | |
| | | Ease | | | Ease | |
| | Stain | stain | Stain | Stain | stain | Stain |
| Example | repellency | removal | resistance | repellency | removal | resistance |
| EX-25 | 2 | 1 | 8 | 2 | 1 | 8 |
| EX-26 | 1 | 1 | 8 | 2 | 1 | 8 |
| EX-27 | 1 | 1 | 8 | 2 | 1 | 8 |
| EX-28 | 1 | 1 | 8 | 1 | 1 | 8 |
| REF-5 | 5 | 3 | 1 | 5 | 3 | 3 |

### Examples EX-29 to EX-32 and Reference Example REF-6

In Examples EX-29 to EX-32, chrome plated ABS test panels were dip coated with a solution containing polysiloxane functionalized with a phosphate group (SiPhat1) or phosphonate group (SiPhon1) using the RDC-21 equipment. The treatment formulation was prepared in a solvent mixture of 80% PnB and 20% DPM. After drying for 10 minutes at 85° C., the stain release was evaluated according to the methods described above. The results are recorded in Table 12.

TABLE 12

| | | Stain release Artline Blue | | |
|---|---|---|---|---|
| | Treatment | Chrome plated ABS | | |
| | composition | rinsed with IPA | | |
| | in | | Ease | |
| | PnB/DPM | Stain | stain | Stain |
| Example | (80/20) | repellency | removal | resistance |
| EX-29 | 0.1% SiPhat1 | 1 | 1 | 8 |
| EX-30 | 0.2% SiPhat1 | 1 | 1 | 8 |
| EX-31 | 0.1% SiPhon1 | 1 | 1 | 8 |
| EX-32 | 0.2% SiPhon1 | 2 | 1 | 8 |
| REF-6 | untreated | 5 | 2 | 5 |

As shown in Table 12 the treatment compositions according to the present disclosure provide improved stain release properties against permanent Artline Blue marker on chrome panel ABS panels.

### Examples EX-33 to EX-36 and Reference Example REF-7

In Examples EX-33 to EX-36 chrome plated ABS test panels were treated with polysiloxane functionalized with a phosphate group (SiPhat1) or phosphonate group (SiPhon1) dissolved in isoparaffin ISOPAR L. The use of this solvent may better prevent delamination of the chrome layer from the ABS. The test panels were dip coated using the RDC-21 equipment and either dried at room temperature or dried for 10 minutes at 85° C. After drying the stain release was evaluated according to the methods described above. It was observed that the results of stain release were the same, independent of the drying conditions. It was further observed that treatment formulations having as low as 0.06% concentration of polysiloxane functionalized with a phosphate or phosphonate group are effective. The results are recorded in Table 13.

TABLE 13

| | Treatment | Stain release Artline Blue | | |
|---|---|---|---|---|
| | composition | Dried at RT or 10 min at 85° C. | | |
| | in | Stain | Ease stain | Stain |
| Example | ISOPAR L | repellency | removal | resistance |
| EX-33 | 0.06% SiPhat1 | 1 | 1 | 8 |
| EX-34 | 0.10% SiPhat1 | 1 | 1 | 8 |
| EX-35 | 0.06% SiPhon1 | 1 | 1 | 8 |
| EX-36 | 0.10% SiPhon1 | 1 | 1 | 8 |
| REF-7 | untreated | 5 | 3 | 3 |

### Examples EX-37 to EX-40

In Examples EX-37 to EX-40, the stability of the treatment bath containing polysiloxane functionalized with a phosphate group (SiPhat1) or phosphonate group (SiPhon1) in ISOPAR L was evaluated. Freshly made solutions of SiPhat1 or SiPhon1 in ISOPAR L were used to treat chrome plated ABS test panels (rinsed with IPA). The experiment was repeated with the same solutions, that were aged for one, two or even 8 weeks. The treatments were done by dip coating using the RDC-21 equipment. Treated test panels were dried for 10 minutes at 85° C. After drying the stain release was evaluated according to the methods described above. The results are recorded in Table 14.

TABLE 14
Bath stability

| | Treatment | | Stain release Artline Blue | | |
|---|---|---|---|---|---|
| | composition | Treatment | | Ease | |
| | in | Bath | Stain | stain | Stain |
| Example | ISOPAR L | condition | repellency | removal | resistance |
| EX-37 | 0.06% SiPhat1 | Fresh | 1 | 1 | 8 |
| | | 1 wk aging | 1 | 1 | 8 |
| EX-38 | 0.10% SiPhat1 | Fresh | 1 | 1 | 8 |
| | | 1 wk aging | 1 | 1 | 8 |
| | | 2 wks aging | 1 | 1 | 8 |
| | | 8 wks aging | 1 | 1 | 8 |
| EX-39 | 0.06% SiPhon1 | Fresh | 1 | 1 | 8 |
| | | 1 wk aging | 1 | 1 | 8 |
| EX-40 | 0.10% SiPhon1 | Fresh | 1 | 1 | 8 |
| | | 1 wk aging | 1 | 1 | 8 |
| | | 2 wks aging | 1 | 1 | 8 |
| | | 8 wks aging | 1 | 1 | 8 |

It was observed that the treatment baths containing polysiloxanes functionalized with a phosphate or phosphonate group, in ISOPAR L, have a high stability, for at least 8 weeks. The stain release of the treated substrates was not influenced by the aging of the bath.

### Example EX-41

In Example EX-41, the stability of a treatment bath containing polysiloxane functionalized with a phosphonate group (SiPhon1) in PnB/DPM was evaluated. A freshly made solution of 0.1% SiPhon1 in PnB/DPM (80/20) was used to treat chrome plated ABS test panels (rinsed with IPA) and stainless steel test panels. The experiment was repeated with the same solution, that was aged for two weeks. The treatment was done by dip coating using the RDC-21 equipment. Treated test panels were dried for 10 minutes at 85° C. After drying the stain release was evaluated according to the methods described above. The results are recorded in Table 15.

TABLE 15

| | | Stain release Artline Blue | | | Stain release Artline Blue | | |
|---|---|---|---|---|---|---|---|
| | | Chrome plated ABS | | | Stainless steel | | |
| | Treatment | | Ease | | | Ease | |
| | bath | Stain | stain | Stain | Stain | stain | Stain |
| Ex | condition | repellency | removal | resistance | repellency | removal | resistance |
| EX-41 | Fresh | 1 | 1 | 7 | 1 | 1 | 8 |
| | 2 wks aging | 1 | 1 | 7 | 1 | 1 | 8 |

It was observed that also treatment baths containing polysiloxanes functionalized with a phosphonate group, in PnB/DPM, have a high stability, for at least 2 weeks. The stain release of the treated substrates was not influenced by the aging of the bath.

### Examples EX-42 and EX-43 and Reference Example REF-8

In Examples EX-42 and EX-43, aluminum test panels were dip coated with a solution of a polysiloxane functionalized with a phosphate (SiPhat1) or phosphonate group (SiPhon1) in PnB. The treatment was done with the RDC-21 equipment. After dip coating the test panel was dried at 85° C. for 10 minutes. After drying the stain release was evaluated according to the methods described above. The results were compared to Reference example REF-8 The results are recorded in Table 16.

TABLE 16

| | | Stain marker: Artline Blue | | |
|---|---|---|---|---|
| | Treatment | | Ease | |
| | composition | Stain | stain | Stain |
| Example | in PnB | repellency | removal | resistance |
| EX 42 | 0.1% SiPhat1 | 1 | 1 | 8 |
| EX 43 | 0.1% SiPhon1 | 1 | 1 | 8 |
| REF-8 | Untreated | 5 | 3 | 2 |

Table 16 clearly shows that Al test panels treated with polysiloxane functionalized with a phosphate or phosphonate group have much higher stain release properties compared to untreated Al panels.

### Synthesis of 2-Dimethoxyphosphorylethyl prop-2-enoate

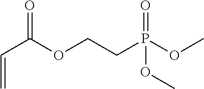

Hydroxyethylphosphonate dimethyl ester (5.0 g, 0.013 mol) was added to a 100-mL round bottom flask. Methylene chloride (50 mL) was added to the flask and the resulting mixture was stirred under an atmosphere of nitrogen. TEA (4.5 mL, 0.013 mol) and DMAP (catalytic amount) were added and the mixture was stirred until the solids dissolved. The flask was then placed in an ice-water bath and stirred for 15 minutes. Acryloyl chloride (2.6 g, 0.013 mol) was added dropwise by syringe with the flask continuously maintained in the ice-water bath and under a nitrogen atmosphere. The ice bath was then removed and the reaction was stirred overnight at room temperature. The reaction mixture was then diluted with 60 mL of methylene chloride, quenched with saturated sodium bicarbonate and the two phases were separated. The aqueous portion was extracted with two additional portions of methylene chloride. The organic phases were combined and washed twice with a 5 weight percent aqueous solution of monosodium phosphate, followed by washing with water and finally brine. The organic portion was dried over sodium sulfate, filtered and concentrated under reduced pressure to provide 2-dimethoxyphosphorylethyl prop-2-enoate as an amber oil. ¹H-NMR (CDCl₃, 500 MHz) δ 2.22 (dt, 2H), 3.77 (m, 6H), 4.4 (dt, 2H), 5.87 (dd, 1H), 6.12 (dd, 1H), 6.44 (dd, 1H).

### Synthesis of 2-Bis(trimethylsilyloxy)phosphorylethyl prop-2-enoate

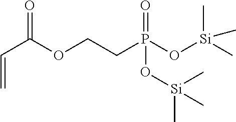 [SMILES: C=CC(=O)OCCP(=O)(O[Si](C)(C)C)O[Si](C)(C)C]

2-Dimethoxyphosphorylethyl prop-2-enoate (3.5 g, 16.8 mmol) and dry dichloromethane (30 mL) were added to a 100-mL round bottom flask and maintained under a nitrogen atmosphere. The flask was placed in ice bath and TMSBr (5.4 g, 35.3 mmol) was added dropwise over a 2-minute period. The ice bath was then removed, and the reaction was stirred for 3 hours at room temperature. The reaction was concentrated under reduced pressure to provide 2-bis(trimethylsilyloxy)phosphorylethyl prop-2-enoate (6 g) as a yellow oil. ¹H NMR (CDCl₃, 500 MHz) δ 0.21-0.28 (m, 18H) 1.97-2.16 (m, 2H) 4.31 (dt, 2H) 5.79 (dd, 1H) 6.05 (dd, 1H) 6.37 (dd, 1H).

### Example EX-44: Synthesis of Polydimethylsiloxane Mono-Phosphonate Acid (SiPhon6)

A glass vial was charged with 2-bis(trimethylsilyloxy)phosphorylethyl prop-2-enoate (0.5 g, 1.5 mmol) and α-monoaminopropyl polydimethylsiloxane (3 g, 1.5 mmol) and stirred at room temperature for 20 hours under N₂ flow. Completion of reaction was confirmed via ¹H-NMR analysis in CDCl₃ (dried over sodium sulfate). The disappearance of the peaks corresponding to the acrylate double bonds indicated full addition of the amine functional PDMS to the acrylate TMS ester adduct. Anhydrous methanol (3 ml) was then added to promote methanolysis of the TMS ester on the phosphonate terminal group. Reaction was stirred for 1 hour at room temperature. Excess solvent was removed by vacuum evaporation. Product was obtained as viscous yellow oil. The product structure was confirmed via ¹H-NMR spectroscopy. SiPhon6 is a 2000 Mw polysiloxane functionalized with one terminal phosphonate group. The product included divalent units represented by the formula I, wherein R is methyl and one terminal unit represented by formula —R¹-Q′-Z, wherein R¹ is propylene, Q¹ is —NH—CH₂CH₂—C(O)—O—CH₂CH₂—, Z is —P(O)(OM)₂, wherein each M is hydrogen.

### Example EX-45: Synthesis of Polydimethylsiloxane Di-Phosphonate Acid (SiPhon7)

A glass vial was charged with 2-bis(trimethylsilyloxy)phosphorylethyl prop-2-enoate (0.65 g, 2 mmol) and α,ω-diaminopropyl polydimethylsiloxane (5 g, 1 mmol). Reaction mixture was stirred at room temperature for 16 hours under N₂ flow. The viscosity of the reaction hindered stirring, hence anhydrous DCM (5 ml) was added to the reaction mixture to help solubilize the reagents. The reaction was stirred for an additional 24 hours. Excess solvent was removed by vacuum evaporation. Completion of the reaction was confirmed by ¹H-NMR analysis in CDCl₃ (dried over sodium sulfate). The hydrolysis of the TMS esters was done by the addition of methanol (4 ml) and stirring the reaction mixture for 1 h at room temperature. Excess solvent was removed by vacuum evaporation. Product was obtained as viscous light yellow oil. The product structure was confirmed via ¹H-NMR spectroscopy. SiPhon7 is a 5000 Mw polysiloxane functionalized with two terminal phosphonate groups. The product included divalent units represented by the formula I, wherein R is methyl and two terminal units represented by formula —R¹-Q¹-Z, wherein R¹ is propylene, Q¹ is —NH—CH₂CH₂—C(O)—O—CH₂CH₂—, Z is —P(O)(OM)₂, wherein each M is hydrogen.

### Examples EX-46 and EX-47

In Examples EX-46 and EX-47 stainless steel test panels (50 mm×25 mm×2 mm) were first soaked overnight in a solution of 0.25 weight % potassium hydroxide in a 50:50 by volume isopropyl alcohol/water. Then each panel was removed and cleaned using Ajax Powder Detergent, available from Colgate Palmolive Company, New York, N.Y. The panels were scrubbed by hand with the Ajax Powder Detergent mixed with deionized water using a Polynit wipe PN-99, 100% PET (Contec Incorporated, Spartanburg, S.C.). The panels were rinsed with deionized water and isopropanol to remove any residue and air dried before testing. The panels were coated within 24 h of the cleaning procedure. Polysiloxane terminated with one (EX-44) or two phosphonate groups (EX-45) dissolved in isopropanol alcohol at 1% weight were applied on the surface using an imbibed polyester knit wipe (PN-99 Polynit wipe from Contec) and dried at room temperature, then wiped with an isopropanol alcohol-moistened wipe to remove any excess coating.

The surface wetting properties of EX-46 and EX-47 compared to an untreated panel REF-9 were investigated by contact angle measurements using the methods WCA-2 and OCA described above. The static and dynamic (advancing and receding) contact angles are summarized in Table 17, below.

TABLE 17

| | Treatment | | | | |
|---|---|---|---|---|---|
| | composition in | WCA-2 (°) | | | OCA (°) |
| Example | ISOPROPANOL | Static | Advancing | Receding | Static |
| EX-46 | 1% EX-44 | 67 | 66 | 28 | 47 |
| EX-47 | 1% EX-45 | 97 | 112 | 22 | 60 |
| REF-9 | — | 73 | 85 | 15 | <10 |

Contact angle analysis demonstrates that among the phosphonate-terminated polysiloxanes, EX-45 yields the most hydrophobic and oleophobic surface as indicated by both advancing/receding water contact angle and static peanut oil contact angle.

### Examples EX-48 and EX-49

Samples EX-48 and EX-49 were treated the same as in EX-46 and EX-47 respectively and then evaluated according to the Peanut Oil Retraction Test and the Peanut Oil Travel Time Test methods described above. Results are compared to an untreated panel REF-10 and reported in Table 18, below.

TABLE 18

| | | Peanut Oil | |
|---|---|---|---|
| | | repellency | |
| | | Percentage | |
| | | of Test | |
| | | Panel | |
| | | Surface | |
| | | Covered | Peanut |
| | | with | Oil |
| | Treatment | Peanut | Travel |
| | composition in | Oil after | Time test |
| Example | ISOPROPANOL | 15 minutes | (seconds) |
| EX-48 | 1% EX-44 | 55% | 8 |
| EX-49 | 1% EX-45 | 32% | 6 |
| REF-10 | — | 100% | 10 |

The complete disclosures of the patents, patent documents and publications cited herein are incorporated by reference in their entirety as if each were individually incorporated. In case of conflict, the present specification, including definitions, shall control. Various modifications and alterations to this invention will become apparent to those skilled in the art without departing from the scope and spirit of this invention. Illustrative embodiments and examples are provided as examples only and are not intended to limit the scope of the present invention. The scope of the invention is limited only by the claims set forth as follows.

1. (canceled)

2. A method of making a treated article having a metal surface, the method comprising treating at least a portion of the metal surface with a composition comprising a polysiloxane functionalized with at least one of a phosphate or phosphonate group, wherein the polysiloxane comprises first divalent units independently represented by formula: 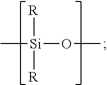
and at least one of
a second divalent unit represented by formula: 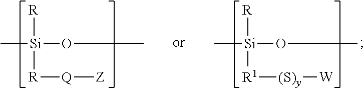
or
a terminal unit represented by formula —R¹-Q′-(Z)_{z} or —R¹—(S)_{y}—W;
wherein
each R is independently alkyl having up to 8 carbon atoms, haloalkyl having up to 8 carbon atoms, alkenyl having up to 8 carbon atoms, phenyl that is unsubstituted or substituted by at least one alkyl or alkoxy having up to 4 carbon atoms or halogen, or benzyl that is unsubstituted or substituted by at least one alkyl or alkoxy having up to 4 carbon atoms or halogen;
each R¹ is independently alkylene, arylene, or alkylene interrupted or terminated by arylene;
each Q is independently a bond, alkylene, arylalkylene, alkylarylene, or arylene, wherein the alkylene, arylalkylene, alkylarylene, and arylene are optionally at least one of interrupted or terminated by at least one ether, thioether, amine, amide, ester, thioester, carbonate, thiocarbonate, carbamate, thiocarbamate, urea, thiourea, or a combination thereof;
each Q′ is independently a bond or divalent or multivalent alkylene, arylalkylene, alkylarylene, or arylene, wherein the divalent or multivalent alkylene, arylalkylene, alkylarylene, and arylene are optionally at least one of interrupted or terminated by at least one ether, thioether, amine, amide, ester, thioester, carbonate, thiocarbonate, carbamate, thiocarbamate, urea, thiourea, or a combination thereof;
y is 0 or 1;
z is 1 or 2;
each W independently comprises divalent units represented by formula 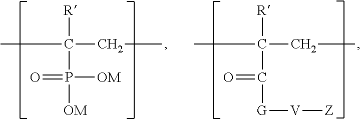
or a combination thereof;
each R′ is independently hydrogen or methyl;
each G is independently selected from the group consisting of —O—, —S—, and —N(R¹¹)—;
each R¹¹ is independently selected from the group consisting of hydrogen and alkyl having from 1 to 4 carbon atoms;
each V is independently alkylene that is optionally interrupted by at least one ether linkage or amine linkage;
each Z is independently —P(O)(OM)₂ or —O—P(O)(OM)₂; and
each M is independently hydrogen, alkyl, trialkylsilyl, a counter cation, or a bond to the metal surface.

3. The method of claim 2, wherein the polysiloxane comprises the second divalent unit represented by formula: 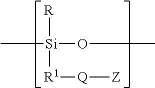
wherein
each R¹ is independently alkylene;
each Q is independently a bond or alkylene optionally at least one of interrupted or terminated by at least one ether or thioether; and
Z is —P(O)(OM)₂ or —O—P(O)(OM)₂, wherein each M is independently hydrogen, a counter cation, or a bond to the metal surface.

4. The method of claim 2, wherein the polysiloxane comprises one or two terminal units represented by formula —R¹-Q′-(Z)_{z};
wherein
each R¹ is independently alkylene;
each Q′ is independently a bond or divalent alkylene optionally at least one of interrupted or terminated by at least one ether, thioether, amine, ester, or combination thereof;
Z is —P(O)(OM)₂ or —O—P(O)(OM)₂, wherein each M is independently hydrogen, a counter cation, or a bond to the surface; and
z is 1.

5. The method of claim 2, wherein the polysiloxane has a number average molecular weight of at least 900 grams per mole.

6. The method of claim 2, wherein the composition further comprises an amino-functional compound having at least one silane group, wherein amino-functional compound is represented by formula:
(R⁶)₂N—[R⁴—Z′]ₐ—R⁴—[Si(X)_{b}(R⁵)_{3-b}]
wherein
R⁴ is arylene or alkylene optionally interrupted or terminated by arylene;
each Z′ is independently —O— or —NR⁶—;
R⁵ is alkyl, aryl, or alkylenyl interrupted or terminated by aryl;
each R⁶ is independently hydrogen, alkyl, aryl, arylalkylenyl, or —R⁴—[Si(Y)ₚ(R⁵)₃₋ₚ];
each X is independently hydroxyl, alkoxy, acetoxy, aryloxy, or halogen;
a is 0, 1, 2, or 3; and
b is 1, 2, or 3.

7. The method of claim 2, further comprising:
treating the metal surface with a primer composition comprising an amino-functional compound having at least one silane group to provide a primed metal surface before treating the metal surface with a composition comprising a polysiloxane having at least one of a phosphate or phosphonate group, wherein the amino-functional compound having at least silane group is represented by formula:
(R⁶)₂N—[R⁴—Z′]ₐ—R⁴—[Si(X)_{b}(R⁵)_{3-b}]
wherein
each R⁴ is independently arylene or alkylene optionally interrupted or terminated by arylene;
each Z′ is independently —O— or —NR⁶—;
R⁵ is alkyl, aryl, or alkylenyl interrupted or terminated by aryl;
each R⁶ is independently hydrogen, alkyl, aryl, arylalkylenyl, or —R⁴—[Si(Y)ₚ(R⁵)₃₋ₚ];
each X is independently hydroxyl, alkoxy, acetoxy, aryloxy, or halogen;
a is 0, 1, 2, or 3; and
b is 1, 2, or 3.

8. The method of claim 6, wherein the amino-functional compound having at least one silane group is bis(3-trimethoxysilylpropyl)amine, N-methyl-bis(3-trimethoxysilylpropyl)amine, N,N′-bis[3-trimethoxysilylpropyl]-ethylenediamine, bis(3-triethoxysilylpropyl)amine, N-methyl-bis(3-triethoxysilylpropyl)amine, N,N′-bis[3-triethoxysilylpropyl]-ethylenediamine, or a combination thereof.

9. The method of claim 2, wherein the metal surface comprises at least one of chromium, chromium alloys, iron, aluminum, copper, nickel, titanium, zinc, tin, stainless steel, mild steel, or brass.

10. A composition comprising:
a polysiloxane having at least one of a phosphate or phosphonate group; and
an amino-functional compound having at least one silane group.

11. The composition of claim 10, wherein the polysiloxane comprises first divalent units independently represented by formula: 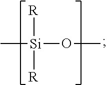
and at least one of
a second divalent unit represented by formula: 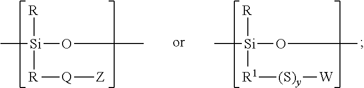
or
a terminal unit represented by formula —R¹-Q′-(Z)_{z} or —R¹—(S)_{y}—W;
wherein
each R is independently alkyl having up to 8 carbon atoms, haloalkyl having up to 8 carbon atoms, alkenyl having up to 8 carbon atoms, phenyl that is unsubstituted or substituted by at least one alkyl or alkoxy having up to 4 carbon atoms or halogen, or benzyl that is unsubstituted or substituted by at least one alkyl or alkoxy having up to 4 carbon atoms or halogen;
each R¹ is independently alkylene, arylene, or alkylene interrupted or terminated by arylene;
each Q is independently a bond, alkylene, arylalkylene, alkylarylene, or arylene, wherein the alkylene, arylalkylene, alkylarylene, and arylene are optionally at least one of interrupted or terminated by at least one ether, thioether, amine, amide, ester, thioester, carbonate, thiocarbonate, carbamate, thiocarbamate, urea, thiourea, or a combination thereof;
each Q′ is independently a bond or divalent or multivalent alkylene, arylalkylene, alkylarylene, or arylene, wherein the divalent or multivalent alkylene, arylalkylene, alkylarylene, and arylene are optionally at least one of interrupted or terminated by at least one ether, thioether, amine, amide, ester, thioester, carbonate, thiocarbonate, carbamate, thiocarbamate, urea, thiourea, or a combination thereof;
y is 0 or 1;
z is 1 or 2;
W comprises divalent units represented by formula 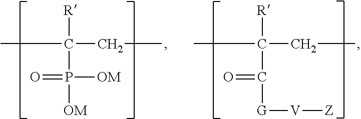
or a combination thereof,
each R′ is independently hydrogen or methyl;
each G is independently selected from the group consisting of —O—, —S—, and —N(R⁷)—;
each R⁷ is independently selected from the group consisting of hydrogen and alkyl having from 1 to 4 carbon atoms;
each V is independently alkylene that is optionally interrupted by at least one ether linkage or amine linkage;
each Z is independently —P(O)(OM)₂ or —O—P(O)(OM)₂; and
each M is independently hydrogen, alkyl, trialkylsilyl, a counter cation.

12. The composition of claim 11, wherein the polysiloxane comprises the second divalent unit represented by formula: 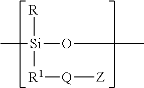
wherein
each R¹ independently alkylene;
each Q is independently a bond or alkylene optionally at least one of interrupted or terminated by at least one ether or thioether; and
Z is —P(O)(OM)₂ or —O—P(O)(OM)₂, wherein each M is independently hydrogen or a counter cation.

13. The composition of claim 11, wherein the polysiloxane comprises one or two terminal units represented by formula —R¹-Q′-(Z)_{z};
wherein
each R¹ is independently alkylene;
each Q′ is independently a bond or divalent alkylene optionally at least one of interrupted or terminated by at least one ether, thioether, amine, ester, or combination thereof;
Z is —P(O)(OM)₂ or —O—P(O)(OM)₂, wherein each M is independently hydrogen or a counter cation; and
z is 1.

14. A polysiloxane comprising first divalent units independently represented by formula: 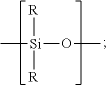
and at least one of
a second divalent unit represented by formula: 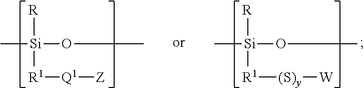
or
a terminal unit represented by formula —R¹-Q¹-Z or —R¹—(S)_{y}—W;
wherein
each R is independently alkyl having up to 8 carbon atoms, haloalkyl having up to 8 carbon atoms, alkenyl having up to 8 carbon atoms, phenyl that is unsubstituted or substituted by at least one alkyl or alkoxy having up to 4 carbon atoms or halogen, or benzyl that is unsubstituted or substituted by at least one alkyl or alkoxy having up to 4 carbon atoms or halogen;
each R¹ is independently alkylene, arylene, or alkylene optionally interrupted or terminated by arylene;
each Q¹ is independently alkylene, arylalkylene, alkylarylene, or arylene, wherein the alkylene, arylalkylene, alkylarylene, and arylene are at least one of interrupted or terminated by at least one amine, amide, ester, thioester, carbonate, thiocarbonate, carbamate, thiocarbamate, urea, thiourea, or a combination thereof;
y is 0 or 1;
each W independently comprises divalent units represented by formula 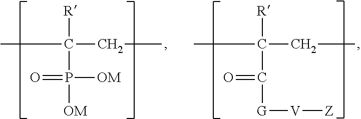
or a combination thereof;
each R′ is independently hydrogen or methyl;
each G is independently selected from the group consisting of —O—, —S—, and —N(R¹¹)—;
each R¹¹ is independently selected from the group consisting of hydrogen and alkyl having from 1 to 4 carbon atoms;
each V is independently alkylene that is optionally interrupted by at least one ether linkage or amine linkage;
each Z is independently —P(O)(OM)₂ or —O—P(O)(OM)₂; and
each M is independently hydrogen, alkyl, trialkylsilyl, or a counter cation.

15. The polysiloxane of claim 14, wherein the polysiloxane comprises two terminal units represented by formula —R¹-Q¹-Z, wherein
each R¹ is independently alkylene;
each Q¹ is independently alkylene at least one of interrupted or terminated by amine, ester, or a combination thereof; and
each Z is independently —P(O)(OM)₂.

16. The composition or polysiloxane of claim 14, wherein at least 80 percent of the R groups are methyl.

17. The composition of claim 11, wherein the polysiloxane comprises the second divalent unit represented by formula: 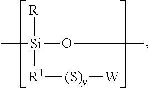
wherein
each R¹ is alkylene;
y is 1;
W comprises divalent units represented by formula 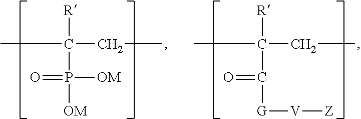
or a combination thereof;
each R′ is independently hydrogen or methyl;
each G is —O—;
V is alkylene;
each Z is independently —P(O)(OM)₂ or —O—P(O)(OM)₂; and
each M is independently hydrogen or a counter cation.

18. The composition of claim 17, wherein W further comprises divalent units represented by formula
—[CH₂—(R′)C(Si(X′)_{f}(R²)_{3-f})]— or 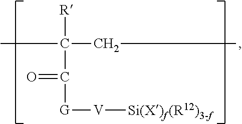
wherein
each R′ is independently hydrogen or methyl;
each G is independently —O—, —S—, or —N(R¹¹)—;
each R¹¹ is independently hydrogen or alkyl having from 1 to 4 carbon atoms;
each V is independently alkylene that is optionally interrupted by at least one ether linkage or amine linkage;
each X′ is independently a hydrolyzable group;
each R¹² is independently alkyl, aryl, arylalkylenyl, or alkylarylenyl; and
f is 1, 2, or 3.

19. The composition of claim 11, wherein the polysiloxane comprises one or two terminal units represented by formula —R¹-Q′-(Z)_{z};
wherein
each R¹ is independently alkylene;
each Q′ is independently a bond or divalent alkylene optionally at least one of interrupted or terminated by at least one ether or thioether;
Z is —P(O)(OM)₂ or —O—P(O)(OM)₂, wherein each M is independently hydrogen or a counter cation; and
z is 1.

20. The composition of claim 11, wherein the polysiloxane comprises one or two terminal units represented by formula —R¹—(S)_{y}—W, wherein
each R¹ is alkylene;
y is 1;
each W independently comprises divalent units represented by formula 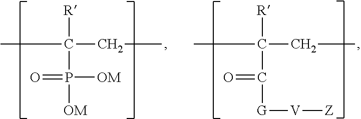
or a combination thereof;
each R′ is independently hydrogen or methyl;
each G is —O—;
V is alkylene;
each Z is independently —P(O)(OM)₂ or —O—P(O)(OM)₂; and
each M is independently hydrogen, a counter cation, or a bond to the metal surface.

21. The composition of claim 11, wherein at least 80 percent of the R groups are methyl.
